(19) United States
(12) Patent Application Publication
(10) Pub. No.: US 2011/0125313 A1
(43) Pub. Date: May 26, 2011

(54) Banknote processing apparatus, banknote sorting method, and computer readable recording medium

(75) Inventors: Tsuyoshi Hodatsu, Hyogo (JP); Osamu Uehara, Hyogo (JP)

(73) Assignee: GLORY LTD.

(21) Appl. No.: 12/927,774

(22) Filed: Nov. 23, 2010

(30) Foreign Application Priority Data
Nov. 24, 2009 (JP) 2009-266852

(51) Int. Cl. G06F 7/00; G07F 7/04

(52) U.S. Cl. 700/223; 194/206

(57) ABSTRACT

A banknote processing apparatus includes a banknote transport unit for individually feeding and transporting inserted banknotes, a recognition unit for recognizing banknote denominations and recognizing banknote types according to two fitness categories, a stacker for stacking the banknotes based on the recognition result, banknote bundling units each including bundling stacking units for stacking the banknotes, a bundling unit for bundling 100 banknotes stacked in the bundling stacking units to prepare a banknote bundle, and a bundle dispensing unit for dispensing the bundle to the outside of the apparatus, and a transport control unit for recognizing fit and unfit notes of specific denominations via the recognition unit, and controlling the banknote transport unit to stack fit banknotes of the specific denominations to corresponding bundling stacking units and to stack unfit banknotes of the specific denominations to corresponding bundling stacking units.

### CROSS-REFERENCE TO RELATED APPLICATIONS

This application is based upon and claims the benefit of priority from Japanese Patent Application No. 2009-266852, filed on Nov. 24, 2009, the entire contents of which are incorporated herein by reference.

### BACKGROUND OF THE INVENTION

1. Field of the Invention

The present invention relates to a banknote processing apparatus that is equipped with a function of sorting banknotes according to a degree of stain on the banknotes, and relates to a banknote sorting method and a computer readable recording medium which stores a banknote sorting program.

2. Description of the Related Art

Apparatuses that include a recognition unit, a bundling stacking unit, and a bundling unit are well known conventional banknote processing apparatuses (for example, see Japanese Laid-open Patent Publication No. 2002-197509 and Japanese Laid-open Patent Publication No. 2006-107061). The recognition unit recognizes denominations or fitness types of banknotes inserted in the apparatus. The bundling stacking unit temporarily stacks the inserted banknotes according to predetermined denominations or the fitness types. The bundling unit bundles a predetermined number of banknotes, which are stacked in the bundling stacking unit according to the predetermined denominations or the fitness types, with a bundling band, so that a banknote bundle is prepared. These banknote processing apparatuses can prepare banknote bundles according to the predetermined denominations or the fitness types.

Apparatuses that prepare banknote bundles of fit notes and banknote bundles of unfit notes by changing bundling positions when preparing the banknote bundles of fit notes and the banknote bundles of unfit notes are also known as conventional banknote processing apparatuses (for example, see Japanese Patent No. 2886554). Operators of these banknote processing apparatuses can distinguish between the banknote bundles of fit notes and the banknote bundles of unfit notes based on the bundling positions.

Apparatuses that print a fitness level on bundling bands on banknote bundles when preparing banknote bundles of fit notes and banknote bundles of unfit notes are also known as conventional banknote processing apparatuses (for example, see Japanese Laid-open Patent Publication No. H05-229518). Operators of these banknote processing apparatuses can distinguish between the banknote bundles of fit notes and the banknote bundles of unfit notes based on the printed contents on the bundling bands.

Apparatuses in which a fitness level of banknotes is classified into three levels, which are high, medium, and low, and stacking units are provided for the respective three fitness levels such that the fitness levels of inserted banknotes are recognized and the banknotes are stacked in the stacking units according to the fitness levels are also known as conventional banknote processing apparatuses (for example, see Japanese Laid-open Patent Publication No. H06-96325). These banknote processing apparatuses can sort inserted banknotes according to the three fitness levels, which are high, medium, and low.

Apparatuses that include stacking units for each damage condition or each type of stain on banknotes, recognize the damage conditions or the types of stain on inserted banknotes, and sorts and stacks the banknotes in the stacking units according to the damage conditions or the types of stain are also known as conventional banknote processing apparatuses (for example, see Japanese Laid-open Patent Publication No. 2006-350818). These banknote processing apparatuses can sort inserted banknotes according to the damage conditions or the types of stains on the banknotes.

In recent years, there is a demand by, for example, banks to collect banknote bundles of identical denominations according to fitness categories of fit notes and unfit notes. For example, in the case of Euro banknotes, 10 Euro banknotes, 20 Euro banknotes, and 50 Euro banknotes account for about 90% of the whole amount of Euro banknotes in circulation, and banknote processing operations for these Euro banknotes constitute the majority of the whole banknote processing operations. In addition, the European Central Bank is making an effort to collect unfit banknotes in the form of a banknote bundle according to predetermined standards. Therefore, it is desired by banks or the like to sort banknotes, in particular 20 Euro banknotes and 50 Euro banknotes which are in wide circulation, into fit notes and unfit notes and collect banknote bundles of fit notes for reuse and banknote bundles of unfit notes for return to the European Central Bank.

In the conventional banknote processing apparatuses, when, for example, bundles of fit 20 Euro banknotes, bundles of unfit 20 Euro banknotes, bundles of fit 50 Euro banknotes, and bundles of unfit 50 Euro banknotes, which are bundles of banknotes in wide circulation, are to be collected out of banknotes of mixed denominations, at least four bundling stacking units and one bundling unit are needed. However, in the conventional banknote processing apparatuses, because one bundling unit is provided for four bundling stacking units, processing load on the bundling unit increases, leading to decrease in operation speed for preparing banknote bundles. Therefore, in the banknote processing apparatuses, an operational burden on the operator for collecting banknote bundles of fit notes of specific denominations and banknote bundles of unfit notes of specific denominations increases.

### SUMMARY OF THE INVENTION

It is an object of the present invention to at least partially solve the problems in the conventional technology.

A banknote processing apparatus according to an aspect of the present invention includes a transport unit for feeding inserted banknotes one by one and transporting the banknotes; a recognition unit for recognizing denominations of the banknotes fed by the transport unit, and recognizing a degree of stain on the banknotes, the denominations of which have been recognized, according to two fitness categories of a fit note and an unfit note; a plurality of banknote bundling units, each of which includes a plurality of bundling stacking units for stacking the banknotes recognized by the recognition unit to bundle the banknotes; a bundling unit for bundling a predetermined number of banknotes stacked in the bundling stacking units to prepare a banknote bundle; and a bundle dispensing unit for dispensing the banknote bundle prepared by the bundling unit to the outside of the apparatus; and a control unit for recognizing fit notes and unfit notes of a plurality of specific denominations via the recognition unit, and controlling the transport unit to stack fit banknotes of the specific denominations in bundling stacking units corresponding to fit notes of the specific denominations and stack unfit banknotes of the specific denominations in bundling stacking units corresponding to unfit notes of the specific denominations.

A banknote sorting method according to another aspect of the present invention is for a banknote processing apparatus that includes a transport unit for feeding inserted banknotes one by one and transporting the banknotes, a recognition unit for recognizing denominations of the banknotes fed by the transport unit, and recognizing a degree of stain on the banknotes, the denominations of which have been recognized, according to two fitness categories of a fit note and an unfit note, and a plurality of banknote bundling units, each of which includes a plurality of bundling stacking units for stacking the banknotes recognized by the recognition unit to bundle the banknotes, a bundling unit for bundling a predetermined number of banknotes stacked in the bundling stacking units to prepare a banknote bundle, and a bundle dispensing unit for dispensing the banknote bundle prepared by the bundling unit to the outside of the apparatus. The method includes recognizing fit notes and unfit notes of a plurality of specific denominations via the recognition unit; and controlling the transport unit to stack fit banknotes of the specific denominations in bundling stacking units corresponding to fit notes of the specific denominations and stack unfit banknotes of the specific denominations in bundling stacking units corresponding to unfit notes of the specific denominations.

A computer readable recording medium according to still another aspect of the present invention stores a banknote sorting program for a banknote processing apparatus that includes a transport unit for feeding inserted banknotes one by one and transporting the banknotes, a recognition unit for recognizing denominations of the banknotes fed by the transport unit, and recognizing a degree of stain on the banknotes, the denominations of which have been recognized, according to two fitness categories of a fit note and an unfit note, and a plurality of banknote bundling units, each including a plurality of bundling stacking units for stacking the banknotes recognized by the recognition unit to bundle the banknotes, a bundling unit for bundling a predetermined number of banknotes stacked in the bundling stacking units to prepare a banknote bundle, and a bundle dispensing unit for dispensing the banknote bundle prepared by the bundling unit to the outside of the banknote processing apparatus. The banknote sorting program causes the banknote processing apparatus to execute recognizing fit notes and unfit notes of a plurality of specific denominations via the recognition unit; and controlling, based on a recognition result of the banknotes at the recognizing, the transport unit to stack fit banknotes of the specific denominations in bundling stacking units corresponding to fit notes of the specific denominations and stack unfit banknotes of the specific denominations in bundling stacking units corresponding to unfit notes of the specific denominations.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of the outer configuration of a banknote processing apparatus according to a first embodiment;

FIG. 2 is an explanatory view of the inner configuration of the banknote processing apparatus according to the first embodiment;

FIG. 3 is a plane view of the inner configuration of a bundling stacking unit;

FIG. 4 is a block diagram of the inner configuration of the banknote processing apparatus;

FIG. 5 is an explanatory view illustrating examples of stacking types and bundling details for a first bundling stacking unit and a second bundling stacking unit;

FIG. 6 is an explanatory view illustrating the operation flow of the bundling stacking unit;

FIG. 7 is an explanatory view illustrating the operation flow of a pre-bundling transport unit;

FIG. 8 is an explanatory view illustrating the operation flow of a grip transport unit;

FIG. 9 is an explanatory view briefly illustrating the operation flow of the grip transport unit on a bundling stage;

FIG. 10 is an explanatory view illustrating the operation flow of a dispensing transport unit;

FIG. 11 is a flowchart of a process operation of a control unit that engages in a first specific denomination sorting process according to the first embodiment;

FIG. 12 is a flowchart of a process operation of the control unit that engages in a first bundling stacking process according to the first embodiment;

FIG. 13 is a flowchart of a process operation of the control unit that engages in a second specific denomination sorting process according to a second embodiment; and

FIG. 14 is a flowchart of a process operation of the control unit that engages in a second bundling stacking process according to the second embodiment.

### DETAILED DESCRIPTION OF THE PREFERRED EMBODIMENTS

Embodiments of the present invention will be described in detail below with reference to the accompanying drawings.

First, an overview of the embodiments will be described. Banknote processing apparatuses include a transport unit, a recognition unit, a plurality of banknote bundling units, and a control unit. The transport unit feeds inserted banknotes one by one and transports the banknotes. The recognition unit recognizes denominations of the banknotes fed by the transport unit, and recognizes a degree of stain on the recognized banknotes according to two fitness categories of a fit note and an unfit note.

Each banknote bundling unit includes a bundling stacking unit, a bundling unit, and a bundle dispensing unit. The bundling stacking unit stacks banknotes recognized by the recognition unit to bundle banknotes. The bundling unit bundles a predetermined number of banknotes stacked in the bundling stacking unit to prepare a banknote bundle. The bundle dispensing unit dispenses the banknote bundle prepared by the bundling unit.

The control unit recognizes fit notes and unfit notes of a plurality of specific denominations via the recognition unit. The control unit also controls the transport unit in order to stack fit banknotes of a specific denomination in a bundling stacking unit corresponding to a fit note of the specific denomination and stack unfit banknotes of a specific denomination in a bundling stacking unit corresponding to an unfit note of the specific denomination.

In the banknote processing apparatus, fit banknotes of a specific denomination are stacked in a bundling stacking unit corresponding to a fit note of the specific denomination, and a banknote bundle of the fit notes of the specific denomination is dispensed. In addition, in the banknote processing apparatus, unfit banknotes of a specific denomination are stacked in a bundling stacking unit corresponding to an unfit note of the specific denomination, and a banknote bundle of unfit notes of the specific denomination is dispensed. Therefore, the banknote processing apparatus can significantly reduce an operational burden on the operator when collecting banknote bundles of fit notes and banknote bundles of unfit notes according to a plurality of specific denominations.

### First Embodiment

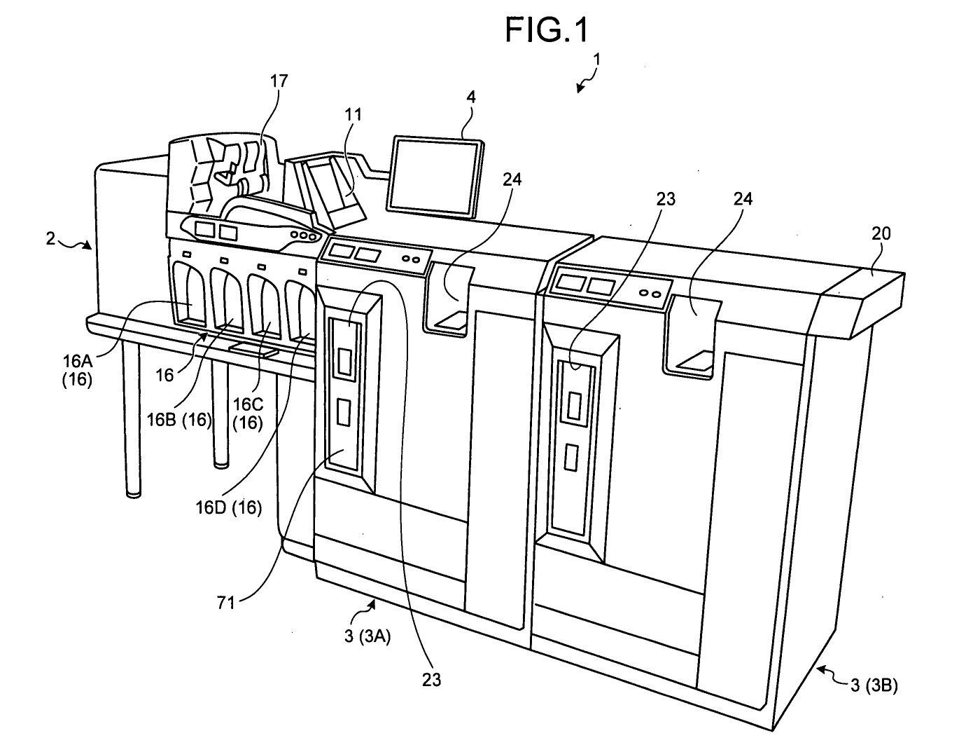

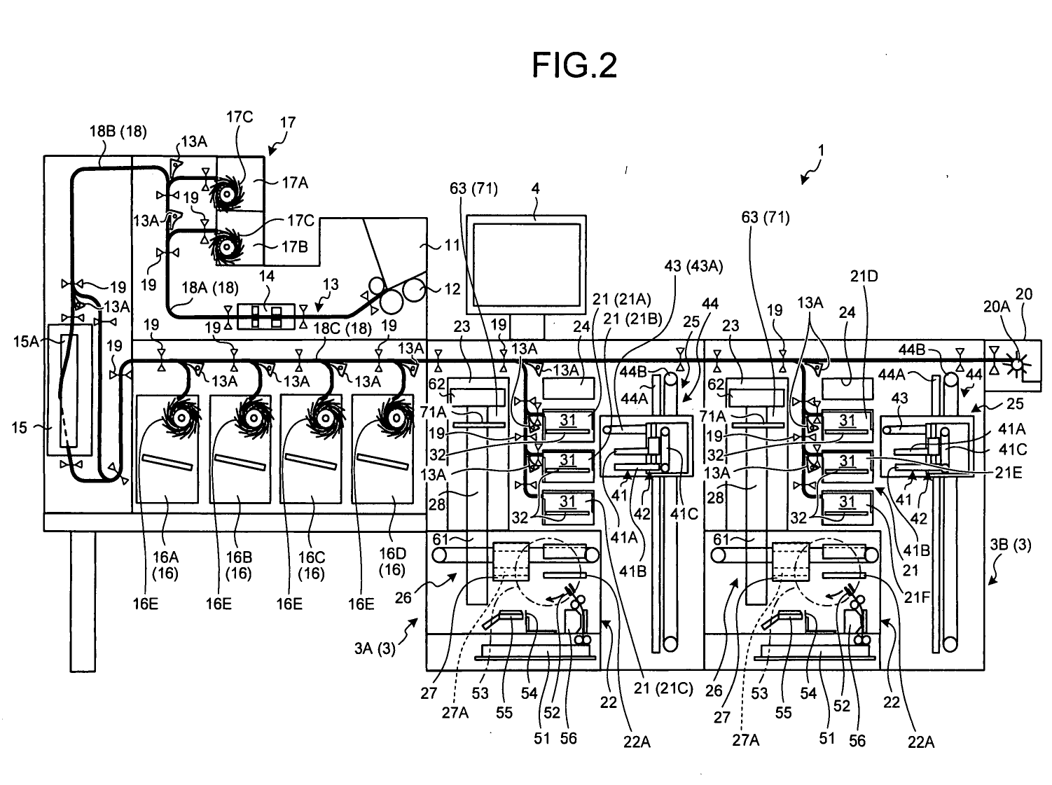

FIG. 1 is a perspective view of the outer configuration of a banknote processing apparatus according to a first embodiment and FIG. 2 is an explanatory view of the inner configuration of the banknote processing apparatus according to the first embodiment.

A banknote processing apparatus 1 includes a banknote sorting unit 2, two banknote bundling units 3 (3A, 3B), and a display unit 4. Banknotes to be handled are successively put in the banknote sorting unit 2, and the banknote sorting unit 2 sorts and stacks the put banknotes according to banknote types and counts the number of each type of put banknotes. The banknote bundling units 3 (3A, 3B) bundle a predetermined number of a specific denomination of banknotes, which are sorted by the banknote sorting unit 2, for example, into a banknote bundle of 100 banknotes. The display unit 4 displays various types of information, for example, on the counting results.

The banknote sorting unit 2 includes a hopper unit 11, a feeding unit 12, a banknote transport unit 13, a diverter unit 13A, a banknote recognition unit 14, a banknote reversing unit 15, a stacker 16, a first rejection unit 17, a banknote transport path 18, detection sensors 19, and a second rejection unit 20. The banknote transport path 18 includes a first transport path 18A, a second transport path 18B, and a third transport path 18C. The first transport path 18A is arranged in an upper position with respect to the stacker 16 and is connected to the hopper unit 11. The second transport path 18B is arranged such that it turns toward the position of the stacker 16 and is connected to the first transport path 18A. The third transport path 18C is connected to the second transport path 18B and is connected to the stacker 16 and bundling stacking units 21 in the banknote bundling units 3. The second transport path 18B consists of an attachable/detachable unit that is connected to the first transport path 18A and the third transport path 18C.

The hopper unit 11 corresponds to an insertion port for inserting banknotes to be handled onto the banknote transport path 18. The feeding unit 12 feeds the inserted banknotes, which are to be handled, one by one onto the banknote transport path 18. The banknote transport unit 13 consists of a transport belt and transports the banknotes, which are fed by the feeding unit 12, onto the banknote transport path 18.

The diverter unit 13A is arranged at a diverter portion on the banknote transport path 18 and sorts banknotes that are transported on the banknote transport path 18 into the stacker 16, the bundling stacking unit 21, the first rejection unit 17, and the second rejection unit 20. Upon detecting, via the detection sensors 19, the entering of the tip of a transported banknote, a solenoid (not shown) is driven and thus the diverter unit 13A sorts the transported banknote. The banknote recognition unit 14 is arranged on the first transport path 18A and recognizes the types of the banknotes that are transported by the banknote transport unit 13. The banknote types include, in the case of Euro banknotes, seven denominations: 5 Euro, 10 Euro, 20 Euro, 50 Euro, 100 Euro, 200 Euro, and 500 Euro, and further include authentication information for recognizing genuine banknotes and counterfeit banknotes and fitness categories for recognizing fit notes and unfit notes. The banknote types still further include front/back information for recognizing the front and back of banknotes and print information for recognizing old or new version of banknotes of each denomination. The unfit notes correspond to banknotes whose degree of stain is determined to be a high level and that are thus determined not to be suitable for circulation. The fit banknotes correspond to banknotes whose degree of stain is determined to be lower than the high level and that are thus determined to be suitable for circulation.

The banknote reversing unit 15 is arranged on the second transport path 18B and sorts transported banknotes at the diverter unit 13A, which is provided in front of the banknote reversing unit 15, into a reverse route and a non-reverse route in accordance with front/back information that represents a banknote type from the banknote recognition unit 14. The banknote reversing unit 15 transports the sorted banknotes to the third transport path 18C with all the transported banknotes facing up or all the transported banknotes facing down. The reverse route has a reversing member 15A, a transport belt (not shown), a drive motor that drives the transport belt, and a guide unit (not shown) (see Japanese Patent No. 4119664). The reversing member 15A has a curved surface that extends in the direction in which the banknotes are transported. The transport belt is suspended so as to be oblique to the longitudinal direction of the reversing member 15A such that a part of the transport belt runs along the curved surface of the reversing member 15A. The guide unit is sandwiched by the transport belt and the reversing member 15A, slides on the banknote surface, and guides the banknote, which is transported in the longitudinal direction of the reversing member 15A while being wound around the curved surface of the reversing member 15A.

In the banknote reversing unit 15, if a banknote is transported with the transport belt being driven by the drive motor, the banknote is sandwiched between the transport belt and the reversing member 15A and is moved in accordance with the movement of the transport belt in the transport direction. In this case, because the transport belt is suspended over the curved surface such that the transport belt is oblique to the longitudinal direction of the reversing member 15A, the banknote is transported while being wound around the curved surface and is reversed while rotating. During the reversion of the banknote, because the guide unit guides the banknote while sliding on the banknote surface, the banknote is reliably reversed while the movement of the banknote is regulated during transport.

For example, when transporting a banknote while keeping it facing up to the third transport path 18C, the banknote reversing unit 15 transports the banknote to the third transport path 18C via the non-reverse route while keeping the transported banknote facing up without performing a reversing process by the banknote reversing unit 15. For example, when transporting a banknote that faces down to the third transport path 18C while reversing the transported banknote to face up, the banknote reversing unit 15 puts the banknote, which faces down, to face up by performing a longitudinal reversing process of the banknote reversing unit 15 via the reverse route and transports the banknote to the third transport path 18C.

The stacker 16 includes first to fourth stackers 16A to 16D for sorting and stacking transported banknotes according to each banknote type, which is set. Each stacker 16 has a stacking wheel 16E that individually stacks transported banknotes in a predetermined position in a banknote stacking space. Each stacker 16 is able to stack 500 banknotes at a maximum, so that 2000 banknotes can be stacked at a maximum by all of the stackers 16. The stacker 16 is a demountable open-type stacker.

Two first rejection units 17 are arranged. The first rejection units 17 reject banknotes that do not apply to the banknote types corresponding to the stacker 16 and the banknote bundling units 3. Each first rejection unit 17 has a stacking wheel 17C that stacks transported banknotes individually in a predetermined position in a banknote stacking space. The detection sensors 19 detect that a transported banknote enters or passes thorough a diverter portion, a confluent portion, or a portion in which devices are connected, on the banknote transport path 18. The second rejection unit 20 is arranged at the end of the third transport path 18C, and includes a fin wheel 20A for stacking transported banknotes individually in a predetermined position in a banknote stacking space.

The banknote bundling units 3 include a first bundling unit 3A and a second bundling unit 3B. The banknote bundling units 3 are not limited to two, and three or more bundling units may be mounted. The first bundling unit 3A includes, in addition to the banknote transport unit 13, the bundling stacking unit 21, a bundling unit 22, a bundle dispensing port 23, an odd note return port 24, a pre-bundling transport unit 25, and a post-bundling transport unit 26. The inner configuration of the second bundling unit 3B is substantially identical to the inner configuration of the first bundling unit 3A, and therefore, identical components and operations are denoted by identical reference numerals and explanation thereof is not repeated. The banknote transport unit 13 transports banknotes of a specific denomination from the banknote transport path 18 in the banknote sorting unit 2 into the banknote bundling unit 3. The bundling stacking unit 21 is vertically three-layered in the banknote bundling unit 3 and sorts and stacks the transported banknotes of the specific denomination.

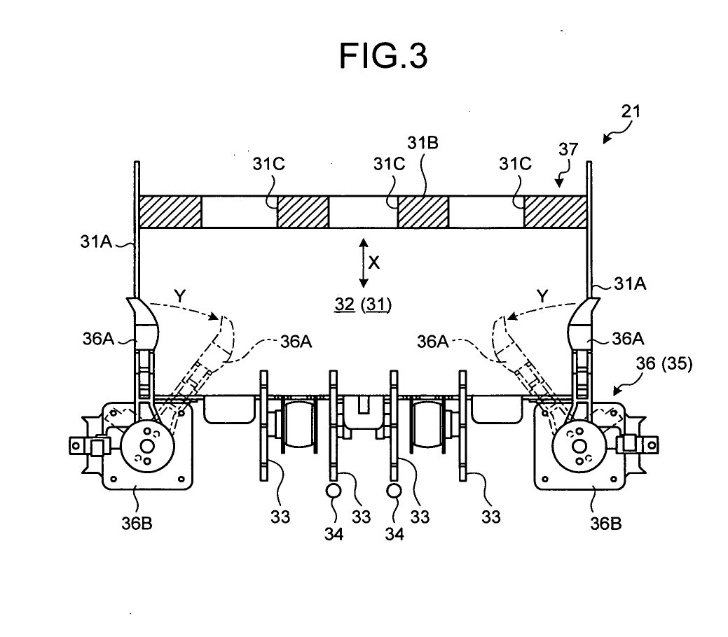

FIG. 3 is an explanatory view of the inner configuration of the bundling stacking unit 21. The bundling stacking unit 21 includes a stacking space 31, a stage unit 32, a fin wheel 33, an enter detection sensor 34, and a size adjustment mechanism 35. The stacking space 31 consists of left and right wall portions 31A and a back wall portion 31B. As illustrated in FIG. 2, the stage unit 32 is arranged in the stacking space 31 such that it can elevate and lower, and transported banknotes are stacked on the stage unit 32. In order to keep the level of the top banknote at a certain level, the stage unit 32 gradually lowers each time a transported banknote is stacked. The fin wheel 33 adjusts the position of transported banknotes that are stacked in the stacking space 31. The enter detection sensor 34 detects entering of a transported banknote into the stacking space 31. The size adjustment mechanism 35 adjusts the stacking space 31 in accordance with the size that is set for banknotes that are stacked in the bundling stacking unit 21.

The size adjustment mechanism 35 includes a banknote arrangement mechanism 36 and a short-edge adjustment mechanism 37. The banknote arrangement mechanism 36 adjusts the position of the to-be-bundled-banknotes in a longitudinal direction, which are stacked in the stacking space 31, in accordance with the size of the set banknote that is to be stacked. The banknote arrangement mechanism 36 includes left and right arm units 36A and left and right stepping motors 36B. The left and right arm units 36A are rotatably arranged at the end portions of the side wall portions 31A in the stacking space 31 and rotate in an inner direction Y in the stacking space 31. The stepping motors 36B rotate the left and right arm units 36A to the set rotation positions in accordance with the set banknote. The tip portions of the left and right arm units 36A hit the edges of stacked banknotes that are stacked on the stage unit 32 in the stacking space 31 so that the position of the stacked banknotes in a longitudinal direction is adjusted.

The short-edge adjustment mechanism 37 can move the back wall portion 31B backwards and forwards in the stacking space 31 in the transport direction X of the banknotes, and adjusts the short edge size of the stacking space 31 in the stacking space 31 in accordance with the short edge size of the set banknote that is to be stacked. The back wall portion 31B has, for example, three cutouts 31C. The cutouts 31C let a hand unit 41 (see FIG. 2) of the pre-bundling transport unit 25 enter the stacking space 31. The lower portion of the back wall portion 31B is an openable and closable shutter structure. Therefore, the hand unit 41 can grip the long edge of the to-be-bundled-banknotes in the stacking space 31 via the cutouts 31C and the gripped to-be-bundled-banknotes can be pulled out of the stacking space 31.

The bundling unit 22 is arranged in a lower position with respect to the three bundling stacking units 21 (see FIG. 2). If the number of to-be-bundled-banknotes that are stacked in the bundling stacking unit 21 reaches a predetermined number (for example, 100), the bundling unit 22 prepares a banknote bundle by bundling 100 banknotes with a bundling band. The bundling unit 22 further includes a bundling band reel 51, a bundling band stopper 52, a pivot arm 53, a cutter unit 54, a heater unit 55, and a printing unit 56. The bundling band reel 51 is a part for storing bundling bands. In a state in which a bundling position on the to-be-bundled-banknotes is set to a bundling operation position on a bundling stage, the bundling band stopper 52 stops the tip of a bundling band, which is drawn from the bundling band reel 51, in the bundling position on the to-be-bundled-banknotes. The bundling stage corresponds to a bundling operation area in the bundling unit 22.

The pivot arm 53 draws the bundling band, which is stopped in the bundling position on the to-be-bundled-banknotes, from the bundling band reel 51 and winds the drawn bundling band in the bundling position around the to-be-bundled-banknotes. The cutter unit 54 cuts the other end of the bundling band, which is wound around the bundling position on the to-be-bundled-banknotes. The heater unit 55 thermally bonds the other end of the bundling band, which is cut by the cutter unit 54. The printing unit 56 prints arbitrary characters on the bundling band, which is drawn from the bundling band reel.

The bundle dispensing port 23 is arranged near the hopper unit 11 and corresponds to a dispensing port for dispensing a banknote bundle, which is bundled by the bundling unit 22, to the operator. The odd note return port 24 is arranged near the bundling stacking unit 21 and is a return port for ejecting odd banknotes, which are stacked in the bundling stacking unit 21, to the operator when the handling is complete.

The pre-bundling transport unit 25 transports to-be-bundled-banknotes that are stacked in the bundling stacking unit 21 to the bundling unit 22 or the odd note return port 24. The pre-bundling transport unit 25 grips the long edge of 100 to-be-bundled-banknotes out of the to-be-bundled-banknotes stacked in the bundling stacking unit 21, and transports the 100 to-be-bundled-banknotes to the bundling stage in the bundling unit 22. When the handling is complete, the pre-bundling transport unit 25 grips the odd banknotes, which are less than 100 out of the to-be-bundled-banknotes stacked in the bundling stacking unit 21, and transports the odd banknotes to the odd note return port 24.

The pre-bundling transport unit 25 includes a transport unit 42 including the hand unit 41 and includes a horizontal movement mechanism 43 and a vertical movement mechanism 44. The hand unit 41 of the transport unit 42 collectively grips the long edge of to-be-bundled-banknotes that are stacked in the bundling stacking unit 21. The horizontal movement mechanism 43 is a mechanism that moves the transport unit 42 backwards and forwards (horizontally). The vertical movement mechanism 44 is a mechanism that moves the transport unit 42 up and down (vertically). The vertical movement mechanism 44 includes a guide shaft 44A that is set vertically and extends from the bottom end to the upper end in the banknote bundling unit 3 and a drive belt 44B that guides the transport unit 42 to elevate or lower the transport unit 42 using the guide shaft 44A.

The transport unit 42 includes the hand unit 41 that can move forward or back via a drive belt 43A in the horizontal movement mechanism 43. In the hand unit 41, for example, three grip claws of an upper hand 41A and three grip claws of a lower hand 41B are opposed to each other and the grip claws grip the long edge of the to-be-bundled-banknotes that are stacked in the bundling stacking unit 21. While the lower hand 41B is fixed, the upper hand 41A can move vertically via a drive belt 41C.

The transport unit 42 grips the long edge of the to-be-bundled-banknotes using the grip claws of the upper hand 41A and the grip claws of the lower hand 41B and transports the gripped to-be-bundled-banknotes to the operation preparation position on the bundling stage in the bundling unit 22 or to the odd note return port 24. While gripping the long edge of 100 to-be-bundled-banknotes using the transport unit 42, the pre-bundling transport unit 25 transports the to-be-bundled-banknotes to the operation preparation position on the bundling stage in the bundling unit 22 and arranges the banknotes thereon.

After gripping the banknote bundle that is bundled by the bundling unit 22 and transporting them in the longitudinal direction of the banknotes, the post-bundling transport unit 26 transports them toward the bundle dispensing port 23. The post-bundling transport unit 26 includes a grip transport unit 27 and a dispensing transport unit 28. After the pre-bundling transport unit 25 transports the to-be-bundled-banknotes to the bundling stage in the bundling unit 22, the grip transport unit 27 grips the short edge of the transported to-be-bundled-banknotes and transports the gripped banknotes in the longitudinal direction of the banknotes. The grip transport unit 27 then grips the banknote bundle that has been bundled by the bundling unit 22 and transports the banknote bundle.

While gripping the long edge of 100 to-be-bundled-banknotes via the transport unit 42, the grip transport unit 27 grips the short edge of the 100 to-be-bundled-banknotes at the operation preparation position on the bundling stage in the bundling unit 22. The transport unit 42 in the pre-bundling transport unit 25 releases the grip on the long edge of the to-be-bundled-banknotes, in accordance with operations of the grip transport unit 27 for gripping the short edge of the to-be-bundled-banknotes, and moves to a waiting position.

The grip transport unit 27 includes a grip unit 27A including upper and lower hands that collectively grip the short edge of banknotes. The grip unit 27A grips and transports the to-be-bundled-banknotes in the longitudinal direction of the banknotes from the operation preparation position in order to position and set the bundling position on the banknotes in the bundling operation position on the bundling stage.

While the short edge of the to-be-bundled-banknotes is gripped by the grip unit 27A, once the bundling position-on the to-be-bundled-banknotes is positioned and set in the bundling operation position on the bundling stage, the bundling unit 22 performs the bundling operations for winding the bundling band in the bundling position around the to-be-bundled-banknotes.

When the operations for bundling the to-be-bundled-banknotes are completed by the bundling unit 22, the grip unit 27A returns the banknote bundle to the operation preparation position and transports the banknote bundle into a banknote bundle lift unit 61 in the dispensing transport unit 28. Once the banknote bundle is transported into the banknote bundle lift unit 61, the grip transport unit 27 releases the grip on the short edge of the banknote bundle.

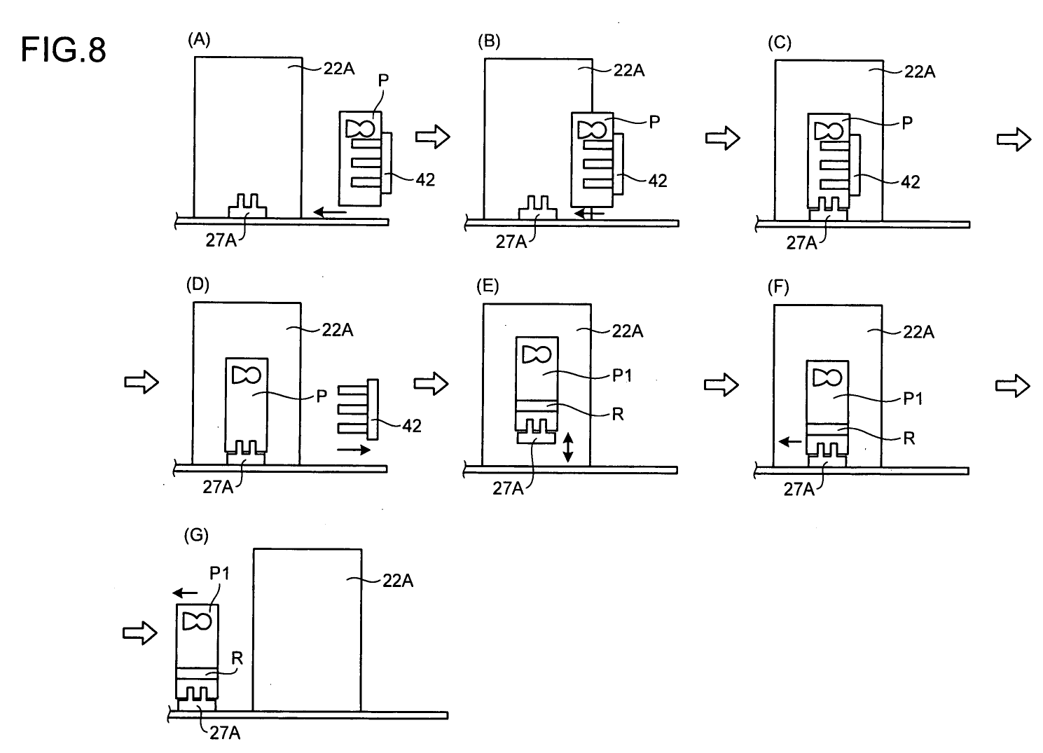

After the pre-bundling transport unit 25 transports the to-be-bundled-banknotes to the operation preparation position on a bundling stage 22A in the bundling unit 22, the grip transport unit 27 grips the short edge of the to-be-bundled-banknotes in the operation preparation position (see FIG. 8(C) for which a description will be given). The pre-bundling transport unit 25 releases the grip on the long edge of the to-be-bundled-banknotes in accordance with the operation of the grip transport unit 27 for gripping the short edge of the to-be-bundled-banknotes. The operation preparation position corresponds to the position in which the to-be-bundled-banknotes are moved and adjusted with respect to the bundling operation position on the bundling stage 22A in which the bundling operations are performed, i.e., the position in which movement in the longitudinal direction of the to-be-bundled-banknotes is started. The bundling operation position corresponds to the operation position in which a bundling band is wound around the to-be-bundled-banknotes.

Once the grip transport unit 27 grips the to-be-bundled-banknotes in the operation preparation position on the bundling stage 22A, the grip transport unit 27 moves and adjusts the to-be-bundled-banknotes in the longitudinal direction of the banknotes in order to set the bundling position on the to-be-bundled-banknotes in the bundling operation position on the bundling stage 22A (see FIG. 8(E) for which a description will be given). The bundling position on the to-be-bundled-banknotes is set in the bundling operation position on the bundling stage 22A and thus the bundling unit 22 winds the bundling band in the bundling position around the to-be-bundled-banknotes. The to-be-bundled-banknotes are moved and adjusted in the longitudinal direction of the banknotes and thus the grip transport unit 27 changes the bundling position on the to-be-bundled-banknotes. Accordingly, the banknote sorting unit 2 winds the bundling band in a different bundling position around the to-be-bundled-banknotes.

When the operation for bundling the to-be-bundled-banknotes in the bundling operation position on the bundling stage 22A is complete while the short edge of the to-be-bundled-banknotes is gripped, the grip transport unit 27 transports the banknote bundle to the operation preparation position (see FIG. 8(F) for which a description will be given). The grip transport unit 27 then transports the banknote bundle to the dispensing transport unit 28.

The dispensing transport unit 28 transports the banknote bundle, which is transported by the grip transport unit 27, to the bundle dispensing port 23. The dispensing transport unit 28 includes the banknote bundle lift unit 61, a push-out mechanism 62, and a dispensing holding mechanism 63. The banknote bundle lift unit 61 transports the banknote bundle, which is transported by the grip transport unit 27, to an upper position of the banknote bundling unit 3. The push-out mechanism 62 pushes out the banknote bundle, which has been transported by the banknote bundle lift unit 61 to the upper position of the banknote bundling unit 3, toward the bundle dispensing port 23 (toward the front surface of the apparatus). The dispensing holding mechanism 63 stacks the banknote bundle, which has been pushed out by the push-out mechanism 62 to the front surface of the apparatus, and dispenses the banknote bundle from the bundle dispensing port 23.

The dispensing holding mechanism 63 includes a bundle stacking unit 71. The bundle stacking unit 71 includes a banknote bundle stage 71A and an open/close plate. The banknote bundle stage 71A is arranged in the bundle stacking unit 71, and a banknote bundle, which has been pushed out by the push-out mechanism 62, is placed on the banknote bundle stage 71A. The banknote bundle stage 71A has a mechanism that adjusts the level of the banknote bundle stage 71A. Therefore, the banknote bundle stage 71A is arranged by the mechanism such that banknote bundles are set to keep the level of the top banknote bundle at a specific position in the bundle stacking unit 71. The open/close plate is a plate that opens or closes an upper opening of the bundle stacking unit 71. When the banknote bundles are pushed toward the front surface of the apparatus by the push-out mechanism 62, the bundled banknotes fall on the banknote bundle stage 71A in the bundle stacking unit 71 in accordance with an opening operation of the open/close plate. The open/close plate performs a closing operation by a spring back force and, for example, performs the opening operation using the weight of a banknote bundle. Alternatively, the open/close operations may be performed by a drive control.

For this description, the bundling stacking unit 21 in the first bundling unit 3A includes a first bundling stacking unit 21A, a second bundling stacking unit 21B, and a third bundling stacking unit 21C, and the bundling stacking unit 21 in the second bundling unit 3B includes a fourth bundling stacking unit 21D, a fifth bundling stacking unit 21E, and a sixth bundling stacking unit 21F.

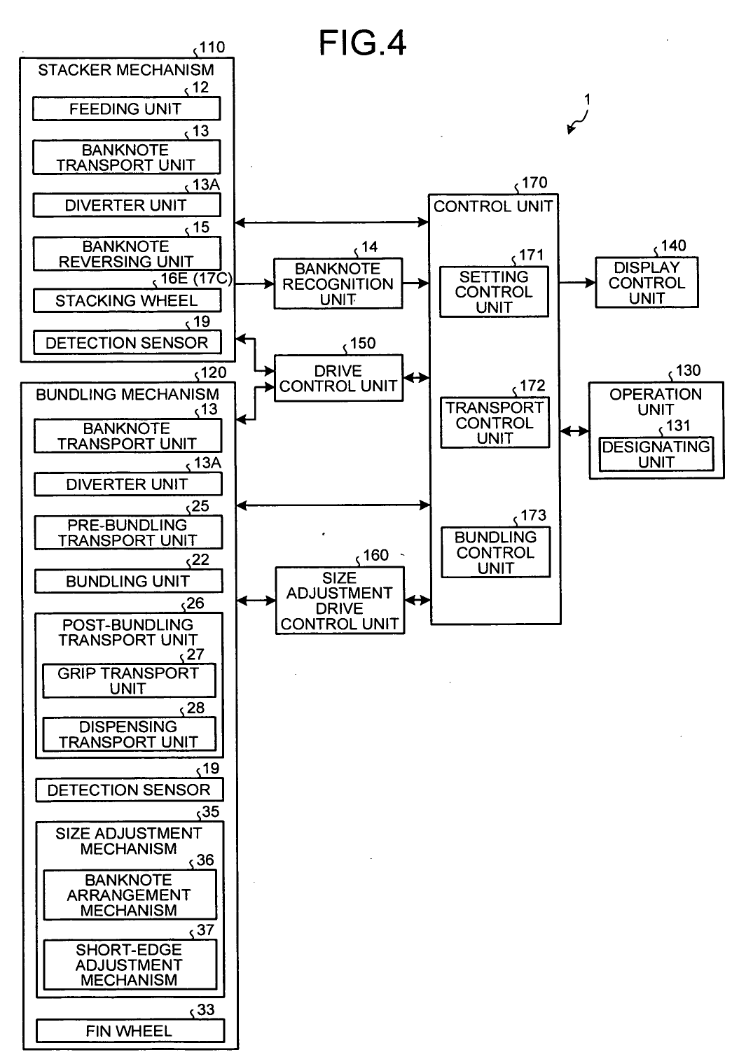

FIG. 4 is a block diagram of the inner configuration of the banknote processing apparatus 1. The banknote processing apparatus 1 illustrated in FIG. 4 includes the banknote recognition unit 14, a stacker mechanism 110, a bundling mechanism 120, an operation unit 130, a display control unit 140, a drive control unit 150, a size adjustment drive control unit 160, and a control unit 170. The stacker mechanism 110 corresponds to the mechanism in the banknote sorting unit 2 and includes the feeding unit 12, the banknote transport unit 13, the diverter unit 13A, the banknote reversing unit 15, the stacking wheel 16E (17C), and the detection sensor 19.

The bundling mechanism 120 corresponds to a mechanism in the banknote bundling unit 3 and includes the banknote transport unit 13, the diverter unit 13A, the detection sensor 19, the bundling unit 22, the pre-bundling transport unit 25, the post-bundling transport unit 26, the fin wheel 33, and the size adjustment mechanism 35. The post-bundling transport unit 26 includes the grip transport unit 27 and the dispensing transport unit 28. The size adjustment mechanism 35 includes the banknote arrangement mechanism 36 and the short-edge adjustment mechanism 37.

The operation unit 130 inputs various commands and includes, for example, a designating unit 131. The designating unit 131 designates banknote types of transported banknotes that are to be stacked in the first to fourth stackers 16A to 16D and the first to sixth bundling stacking units 21A to 21F according to the operation by the operator. For example, as the contents of the designation, the designating unit 131 designates “a fit 50 Euro banknote for the first bundling stacking unit 21A, a fit 20 Euro banknote for the second bundling stacking unit 21B, and a reserve for the third bundling stacking unit 21C” for the first bundling unit 3A. For example, as the contents of the designation, the designating unit 131 designates “an unfit 50 Euro banknote for the fourth bundling stacking unit 21D, an unfit 20 Euro banknote for the fifth bundling stacking unit 21E, and a reserve for the sixth bundling stacking unit 21F” for the second bundling unit 3B.

The display control unit 140 performs display control on the display unit 4. The drive control unit 150 performs drive control on the stacker mechanism 110 and the bundling mechanism 120. The size adjustment drive control unit 160 performs drive control on the size adjustment mechanism 35 in the bundling mechanism 120. The control unit 170 controls the entire banknote processing apparatus 1.

The control unit 170 includes a setting control unit 171, a transport control unit 172, and a bundling control unit 173. The setting control unit 171 sets, for example, the types of banknotes to be stacked (banknotes to be stacked) for the stacker 16, the first rejection unit 17, the second rejection unit 20, and the bundling stacking unit 21 according to the contents designated by the designating unit 131. For example, the setting control unit 171 sets “a 5 Euro banknote for the first stacker 16A, a 10 Euro banknote for the second stacker 16B, a 100 Euro banknote for the third stacker 16C, a 200 Euro banknote for the fourth stacker 16D, and a 500 Euro banknote for a first rejection unit 17A”. As an initial setting for the first bundling unit 3A, the setting control unit 171 sets “a fit 50 Euro banknote for the first bundling stacking unit 21A, a fit 20 Euro banknote for the second bundling stacking unit 21B, and a reserve for the third bundling stacking unit 21C”. As an initial setting for the second bundling unit 3B, the setting control unit 171 sets “an unfit 50 Euro banknote for the fourth bundling stacking unit 21D, an unfit 20 Euro banknote for the fifth bundling stacking unit 21E, and a reserve for the sixth bundling stacking unit 21F”. The control unit 170 identifies errors, such as jamming of banknotes on the banknote transport path 18, according to the detection results of the detection sensor 19.

The transport control unit 172 performs drive control on the banknote transport unit 13 and the diverter unit 13A via the drive control unit 150 in order to sort and stack transported banknotes in the stacker 16 or the bundling stacking unit 21 based on the settings made by the setting control unit 171 according to the banknote type of the transported banknotes. When the transported banknotes are other than banknotes that are set for the stacker 16 and the bundling stacking unit 21, the transport control unit 172 performs drive control on the banknote transport unit 13 and the diverter unit 13A via the drive control unit 150 in order to transport the banknotes to the first rejection unit 17. When the transported banknotes cannot be recognized due to, for example, a transport error, the transport control unit 172 performs drive control on the banknote transport unit 13 and the diverter unit 13A via the drive control unit 150 in order to transport the banknotes to the first rejection unit 17. When detecting an error in transport upstream relative to a first rejection unit 17B, the transport control unit 172 performs drive control on the banknote transport unit 13 and the diverter unit 13A via the drive control unit 150 in order to successively transport the banknotes to the first rejection unit 17B.

When detecting an error in transport downstream relative to the first rejection unit 17B, the transport control unit 172 performs drive control on the banknote transport unit 13 and the diverter unit 13A via the drive control unit 150 in order to successively transport the banknotes to the second rejection unit 20. For example, in a location downstream relative to the first rejection unit 17B, such as in the second transport path 18B or the third transport path 18C, when an error occurs, for example, when a skewed banknote, chained banknotes, or overlapped banknotes are transported on the banknote transport path 18, the error can be recovered more quickly by transporting the error banknotes to the second rejection unit 20 rather than by stopping the banknote transport.

When the transported banknotes are of a banknote type (banknotes to be stacked) that is set for the bundling stacking unit 21, the transport control unit 172 performs drive control on the banknote transport unit 13 and the diverter unit 13A via the drive control unit 150 in order to sort and stack the banknotes in the bundling stacking unit 21. When the number of to-be-bundled-banknotes, which are stacked in the first bundling stacking unit 21A, reaches 100, the transport control unit 172 performs drive control on the pre-bundling transport unit 25 via the drive control unit 150. Accordingly, the hand unit 41 in the transport unit 42 of the pre-bundling transport unit 25 pulls out the to-be-bundled-banknotes that are stacked in the first bundling stacking unit 21A in accordance with the drive control by the drive control unit 150.

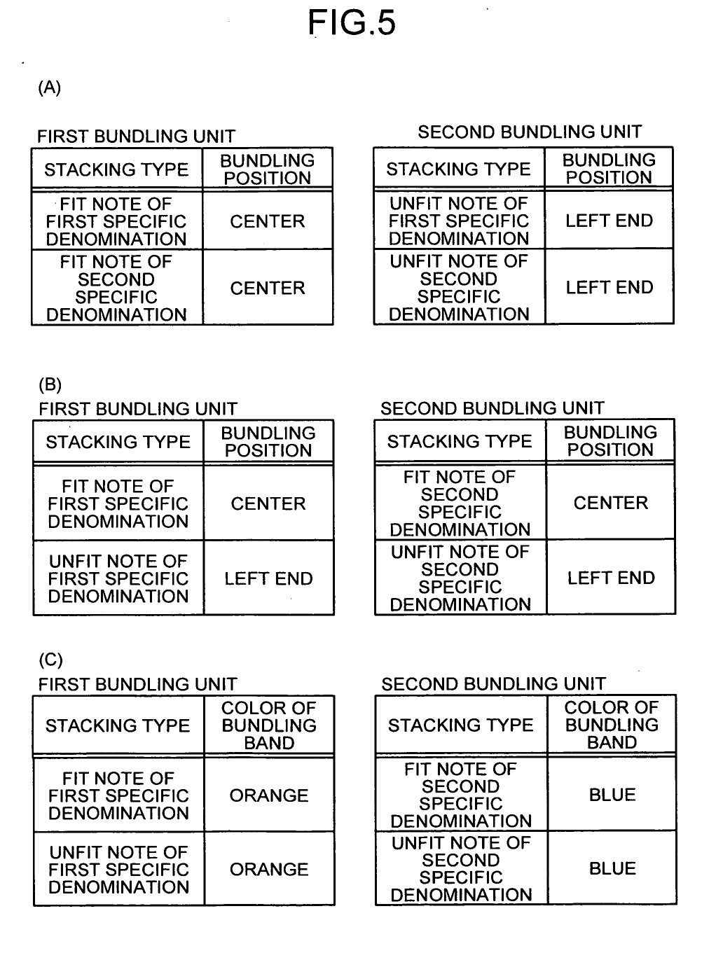

The bundling control unit 173 controls the bundling unit 22 in order to bundle 100 to-be-bundled-banknotes, which are pulled out by the pre-bundling transport unit 25, with a bundling band. For example, when 100 to-be-bundled-banknotes are fit notes, the bundling control unit 173 sets a center portion of the fit banknotes as the bundling position, and controls the bundling unit 22 in order to wind the bundling band in the bundling position (see FIG. 5(A)). When 100 to-be-bundled-banknotes are unfit notes, the bundling control unit 173 sets a left end portion of the unfit banknotes as the bundling position, and controls the bundling unit 22 in order to wind the bundling band in the bundling position.

For example, when the number of fit 50 Euro banknotes that are stacked in the first bundling stacking unit 21A reaches 100, the setting control unit 171 switches the setting for the reserve third bundling stacking unit 21C to a fit 50 Euro banknote. Further, the setting control unit 171 switches the setting for the first bundling stacking unit 21A, from which the fit 50 Euro banknotes, the number thereof has reached 100 banknotes, have been pulled out by the hand unit 41 in the transport unit 42 and which is ready to stack banknotes, to “a reserve”.

At the time when 100 to-be-bundled-banknotes that are stacked in the bundling stacking unit 21 are pulled out, the bundling control unit 173 can recognize the banknote type of the to-be-bundled-banknotes before the bundling operation. Therefore, the bundling control unit 173 performs drive control on the grip transport unit 27 in order to change the setting of the bundling position on the to-be-bundled-banknotes in accordance with the banknote type, and winds the bundling band around the bundling position to bundle the to-be-bundled-banknotes.

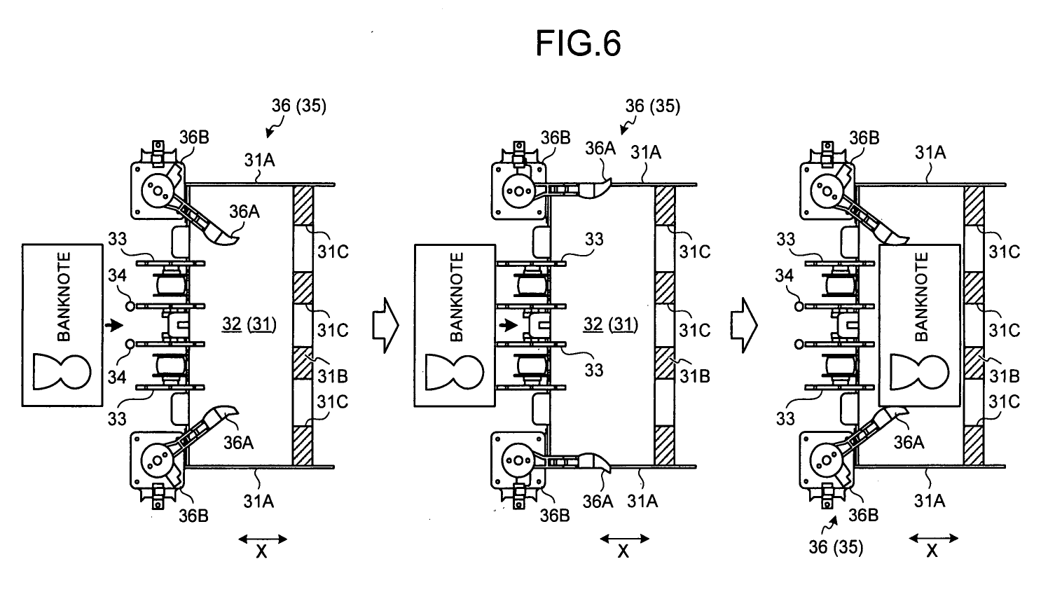

An operation of the size adjustment drive control unit 160 for adjusting the size of the bundling stacking unit 21 will be described below. The size adjustment drive control unit 160 manages the setting rotation position of the arm units 36A in the banknote arrangement mechanism 36 and the short edge size in the short-edge adjustment mechanism 37 according to each banknote type. FIG. 6 is an explanatory view illustrating the operation flow of the bundling stacking unit 21. The size adjustment drive control unit 160 illustrated in FIG. 6 performs drive control on the short-edge adjustment mechanism 37 in order to adjust the stacking space 31 by moving the back wall portion 31B in the direction X in accordance with the set banknote to be stacked. The size adjustment drive control unit 160 performs drive control on the banknote arrangement mechanism 36 in order to set the set rotation position of the arm units 36A of the banknote arrangement mechanism 36 in accordance with the long edge size of the set banknote.

First, the size adjustment drive control unit 160 moves the back wall portion 31B and sets the back wall portion 31B in a position corresponding to the short edge size of the set banknote, and sets the set rotation position corresponding to the long edge size of the set size to the arm units 36A of the banknote arrangement mechanism 36 (see FIG. 6(A)).

Upon detecting the entering of a transported banknote into the stacking space 31 by the enter detection sensor 34, the size adjustment drive control unit 160 opens the left and right arm units 36A (see FIG. 6(B)). After detecting that the transported banknote has passed by the enter detection sensor 34 and then a predetermined time has passed, the size adjustment drive control unit 160 rotates the left and right arm units 36A to the set rotation position. The size adjustment drive control unit 160 then adjusts the position of the long edge of the transported banknotes, which are stacked in the stacking space 31, using the tip portions of the left and right arm units 36A (see FIG. 6(C)). Accordingly, the transported banknotes are successively stacked in the stacking space 31 of the bundling stacking unit 21.

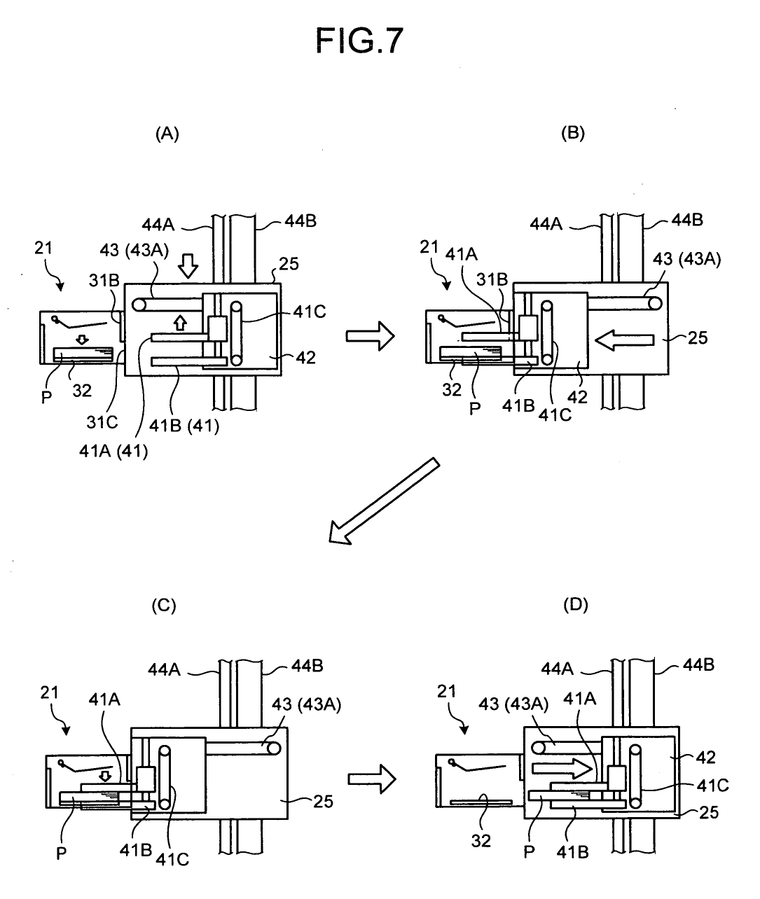

An operation of the pre-bundling transport unit 25 for transporting banknotes (to-be-bundled-banknotes P) that are successively stacked in the stacking space 31 to the operation preparation position in the bundling unit 22 or to the odd note return port 24 will be described below. FIG. 7 is an explanatory view illustrating the operation flow of the pre-bundling transport unit 25.

When pulling out the to-be-bundled-banknotes P by the transport unit 42, the pre-bundling transport unit 25 lowers the stage unit 32 in the bundling stacking unit 21, from which banknote are pulled out, to its lowest position (see FIG. 7(A)). In accordance with the operation of the drive belt 44B, the pre-bundling transport unit 25 lowers the transport unit 42 to a position corresponding to the bundling stacking unit 21, from which banknote are pulled out, i.e., to a position such that the upper surface of the lower hand 413 is lower than the bottom banknote of the to-be-bundled-banknotes P, which are stacked in the bundling stacking unit 21 (see FIG. 7(A)).

The pre-bundling transport unit 25 elevates, by the operation of the drive belt 41C, the upper hand 41A of the transport unit 42 to a position such that the bottom surface of the upper hand 41A is higher than the top banknote of the to-be-bundled-banknotes P (see FIG. 7(A)). Accordingly, the space between the upper hand 41A and the lower hand 41B increases.

The transport unit 42 moves forwards in accordance with the operation of the drive belt 43A of the horizontal movement mechanism 43. In accordance with this forward movement of the transport unit 42, the upper hand 41A and the lower hand 41B enter the bundling stacking unit 21 via the cutouts 31C, which are formed on the back wall portion 31B of the bundling stacking unit 21. Accordingly, the to-be-bundled-banknotes P are positioned between the upper hand 41A and the lower hand 41B (see FIG. 7(B)). The transport unit 42 lowers the upper hand 41A by the operation of the drive belt 41C. In accordance with this lowering operation of the upper hand 41A, the upper hand 41A and the lower hand 41B tightly grip the long edge of the to-be-bundled-banknotes on the stage unit 32 (see FIG. 7(C)).

The transport unit 42 recedes in accordance with the operation of the drive belt 43A of the horizontal movement mechanism 43. In accordance with this receding operation of the transport unit 42, the vertical movement mechanism 44 can move the to-be-bundled-banknotes P, which are held by the upper hand 41A and the lower hand 41B, to the operation preparation position on the bundling stage 22A or to the odd note return port 24 (see FIG. 7(D)).

For example, when the number of the to-be-bundled-banknotes P reaches 100, the drive control unit 150 performs drive control on the pre-bundling transport unit 25 in order to cause the hand unit 41 of the transport unit 42 in the pre-bundling transport unit 25 to enter the stacking space 31 via the cutouts 31C on the back wall portion 31B. The hand unit 41 grips the long edge of the to-be-bundled-banknotes on the stage unit 32 and pulls out the gripped to-be-bundled-banknotes from the bundling stacking unit 21. The drive control unit 150 performs drive control on the pre-bundling transport unit 25 in order to transport the pulled-out to-be-bundled-banknotes to the bundling unit 22 via the horizontal movement mechanism 43 and the vertical movement mechanism 44.

If the number of the to-be-bundled-banknotes P does not reach 100 at the time when the handling finishes, the drive control unit 150 performs drive control on the pre-bundling transport unit 25 in order to cause the hand unit 41 of the transport unit 42 to enter the stacking space 31 via the cutouts 31C on the back wall portion 31B. The hand unit 41 grips the long edge of the to-be-bundled-banknotes on the stage unit 32 and pulls out the gripped odd to-be-bundled-banknotes from the bundling stacking unit 21. The drive control unit 150 performs drive control on the pre-bundling transport unit 25 in order to transport the pulled-out odd to-be-bundled-banknotes to the odd note return port 24 via the horizontal movement mechanism 43 and the vertical movement mechanism 44. After the to-be-bundled-banknotes P that are stacked in the bundling stacking unit 21 are pulled out, the drive control unit 150 elevates the stage unit 32 in the bundling stacking unit 21 to return the transport unit 42 to the normal banknote stacking waiting position.

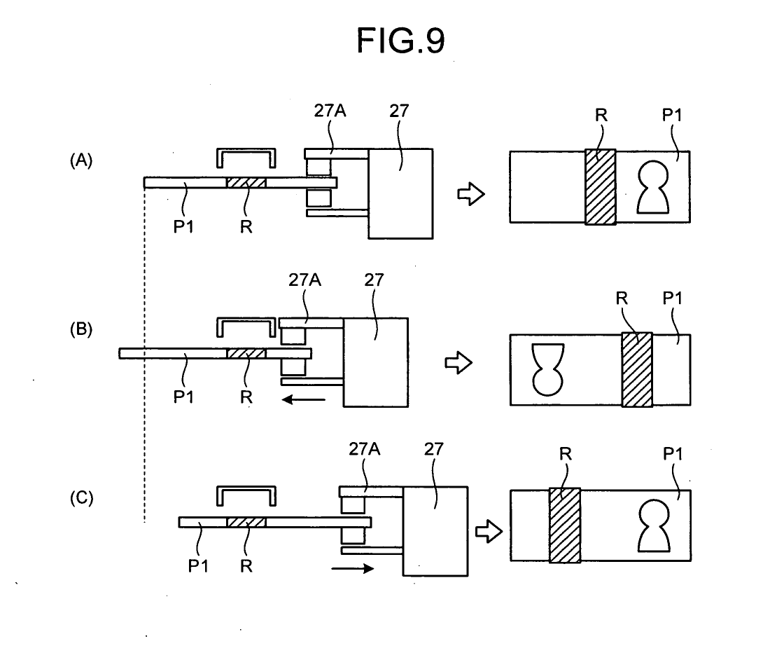

The operation of the grip transport unit 27 for transporting the 100 to-be-bundled-banknotes P that are transported by the pre-bundling transport unit 25 will be described below. FIG. 8 is an explanatory view illustrating the operation flow of the grip transport unit 27. FIG. 9 is an explanatory view illustrating the operation flow of the grip transport unit 27 on the bundling stage 22A. The transport unit 42 of the pre-bundling transport unit 25 illustrated in FIG. 8 grips the long edge of the to-be-bundled-banknotes P, which are stacked in the bundling stacking unit 21, and transports the gripped to-be-bundled-banknotes P to the vicinity of the port of the bundling unit 22 via the horizontal movement mechanism 43 and the vertical movement mechanism (see FIG. 8(A)). The grip unit 27A of the grip transport unit 27 is arranged in the operation preparation position on the bundling stage 22A as illustrated in FIG. 8(A).

The transport unit 42 transports the to-be-bundled-banknotes P to the bundling stage 22A in the bundling unit 22 via the horizontal movement mechanism 43 (see FIG. 8(B)). The transport unit 42 transports the to-be-bundled-banknotes to the operation preparation position on the bundling stage 22A (see FIG. 8(C)). Accordingly, the grip unit 27A of the grip transport unit 27 grips the short edge of the to-be-bundled-banknotes P in the operation preparation position in response to the transport of the to-be-bundled-banknotes P to the operation preparation position by the transport unit 42 (see FIG. 8(C)).

In accordance with the operation of the grip unit 27A of the grip transport unit 27 for gripping the to-be-bundled-banknotes P, the transport unit 42 releases the grip on the long edge of the to-be-bundled-banknotes P (see FIG. 8(D)) and returns to the normal banknote stacking waiting position. The grip unit 27A of the grip transport unit 27 moves in the longitudinal direction of the to-be-bundled-banknotes P in order to position and set the bundling position on the to-be-bundled-banknotes P in the bundling operation position on the bundling stage 22A (see FIG. 8(E)). With the short edge of the to-be-bundled-banknotes P being gripped by the grip unit 27A, the bundling unit 22 winds a bundling band R in the bundling position around the to-be-bundled-banknotes P, which is positioned in the bundling operation position on the bundling stage 22A. Thus, the bundling unit 22 prepares a banknote bundle P1.

The grip transport unit 27 illustrated in FIG. 9(A) positions and sets the center portion of the to-be-bundled-banknotes P, which is the bundling position on the to-be-bundled-banknotes P, in the bundling operation position on the bundling stage 22A. The bundling unit 22 winds the bundling band R around the center portion of the to-be-bundled-banknotes P to prepare a center-bind banknote bundle P1.

The grip transport unit 27 illustrated in FIG. 9(B) positions and sets the gripped end portion (right end portion) of the to-be-bundled-banknotes P, which is the bundling position on the to-be-bundled-banknotes P, in the bundling operation position on the bundling stage 22A. The bundling unit 22 winds the bundling band R around the gripped end portion of the to-be-bundled-banknotes P to prepare a right-end-bind banknote bundle P1.

The grip transport unit 27 illustrated in FIG. 9(C) positions and sets the end portion (left end portion) opposite to the gripped end portion, which is the bundling position on the to-be-bundled-banknotes P, in the bundling operation position on the bundling stage 22A. The bundling unit 22 winds the bundling band R around the end portion opposite to the gripped end portion of the to-be-bundled-banknotes P to prepare a left-end-bind banknote bundle P1.

The grip unit 27A of the grip transport unit 27 moves the banknote bundle P1, which is set and positioned in the bundling operation position on the bundling stage 22A, to the operation preparation position (see FIG. 8 (F)) and transports the banknote bundle P1 to the dispensing transport unit 28 (see FIG. 8(G)).

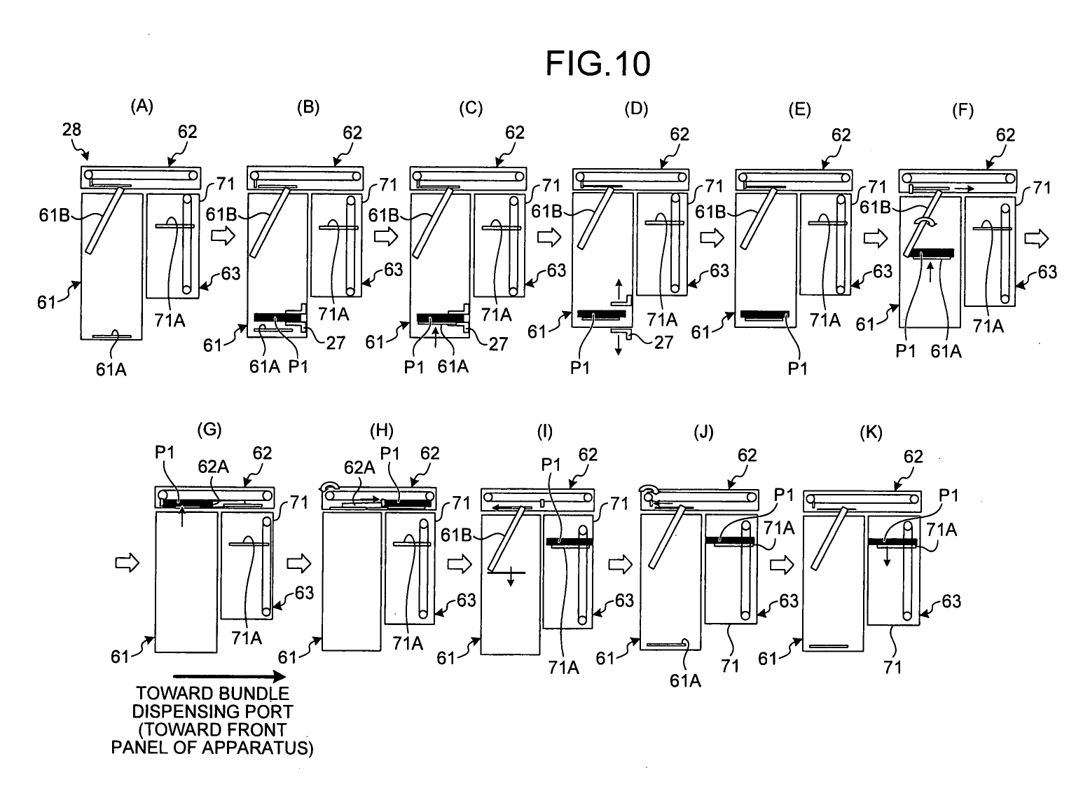

The operation, of the dispensing transport unit 28 of the post-bundling transport unit 26, for transporting the banknote bundle P1, which is transported by the grip transport unit 27, toward the bundle dispensing port 23 will be described below. FIG. 10 is an explanatory view illustrating the operation flow of the dispensing transport unit 28. The banknote bundle lift unit 61 of the dispensing transport unit 28 keeps, at the bottom position, a transport lift 61A for placing the banknote bundle P1 that is gripped and transported by the grip transport unit (see FIG. 10(A)). While gripping the banknote bundle P1 on the transport lift 61A of the banknote bundle lift unit 61, the grip transport unit 27 transports the banknote bundle P1 (see FIG. 10(B)). The banknote bundle lift unit 61 places the banknote bundle P1 on the transport lift 61A in accordance with the elevating operation of the transport lift 61A (see FIG. 10(C)). After placing the banknote bundle P1 on the transport lift 61A and then releasing the grip on the banknote bundle P1 (see FIG. 10(D)), the grip transport unit 27 moves to the operation preparation position (see FIG. 10(E)).

The banknote bundle lift unit 61 then elevates the transport lift 61A on which the banknote bundle P1 is placed. A push-out transport unit 62A of the push-out mechanism 62 is pushed out in response to a link operation of a link mechanism 61B in accordance with the elevation of the transport lift 61A (see FIG. 10(F)), and the banknote bundle P1, which has been placed on the transport lift 61A, is set in the push-out transport unit 62A (see FIG. 10(G)).

The push-out transport unit 62A pushes out and transports the banknote bundle P1, which has been set, toward the front panel of the apparatus (see FIG. 10(H)). The dispensing holding mechanism 63 drops the banknote bundle P1 to the banknote bundle stage 71A in the bundle stacking unit 71 in accordance with the open operation of an open/close plate 71B of the bundle stacking unit 71 and stacks the banknote bundle P1 (see FIG. 10(I)). The banknote bundle lift unit 61 then lowers the transport lift 61A to the bottom position and the push-out transport unit 62A returns to the original waiting state in accordance with the operation of the link mechanism 61B that links with the lowering operation (see FIGS. 10(I) and 10(J)).

The dispensing holding mechanism 63 adjusts the banknote bundle stage 71A in the bundle stacking unit 71 in order to keep the level of the top banknote bundles P1, which are stacked in the bundle stacking unit 71, at a specific position (see FIG. 10(K)).

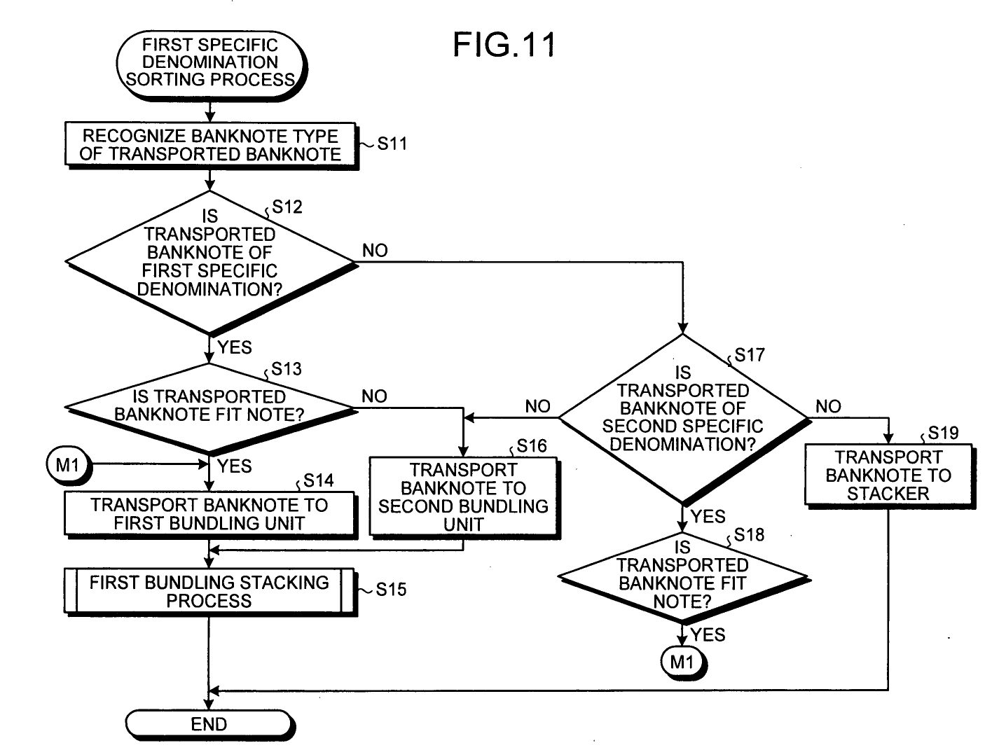

A first specific denomination sorting process for sorting banknotes of, for example, two specific denominations out of a plurality of denominations according to fitness categories will be described below. FIG. 11 is a flowchart of internal process operations of the control unit 170 that engages in the first specific denomination sorting process. The first specific denomination sorting process illustrated in FIG. 11 is a process in which fit banknotes of the specific denominations are sorted in the first bundling unit 3A and unfit banknotes of the specific denominations are sorted in the second bundling unit 3B. The setting control unit 171 in the control unit 170 sets a fit banknote of a first specific denomination and a fit banknote of a second specific denomination as stacked banknotes for the first bundling unit 3A, and sets an unfit banknote of the first specific denomination and an unfit banknote of the second specific denomination as stacked banknotes for the second bundling unit 3B. For example, the setting control unit 171 sets, in the case of Euro banknotes, a 50 Euro banknote for the first specific denomination and a 20 Euro banknote for the second specific denomination, which are in wide circulation.

The control unit 170 recognizes the banknote type of a transported banknote via the banknote recognition unit 14 (Step S11), and determines whether the transported banknote is of the first specific denomination based on the recognition result (Step S12).

When the transported banknote is of the first specific denomination (YES at Step S12), the control unit 170 determines whether the transported banknote is a fit note based on the recognition result (Step S13). When the transported banknote is a fit note (YES at Step S13), the transport control unit 172 in the control unit 170 performs drive control on the banknote transport unit 13 and the diverter unit 13A via the drive control unit 150 (Step S14). Accordingly, the banknote transport unit 13 and the diverter unit 13A transport the fit banknote of the first specific denomination, which is the transported banknote, to the bundling stacking unit 21 in the first bundling unit 3A (Step S14).

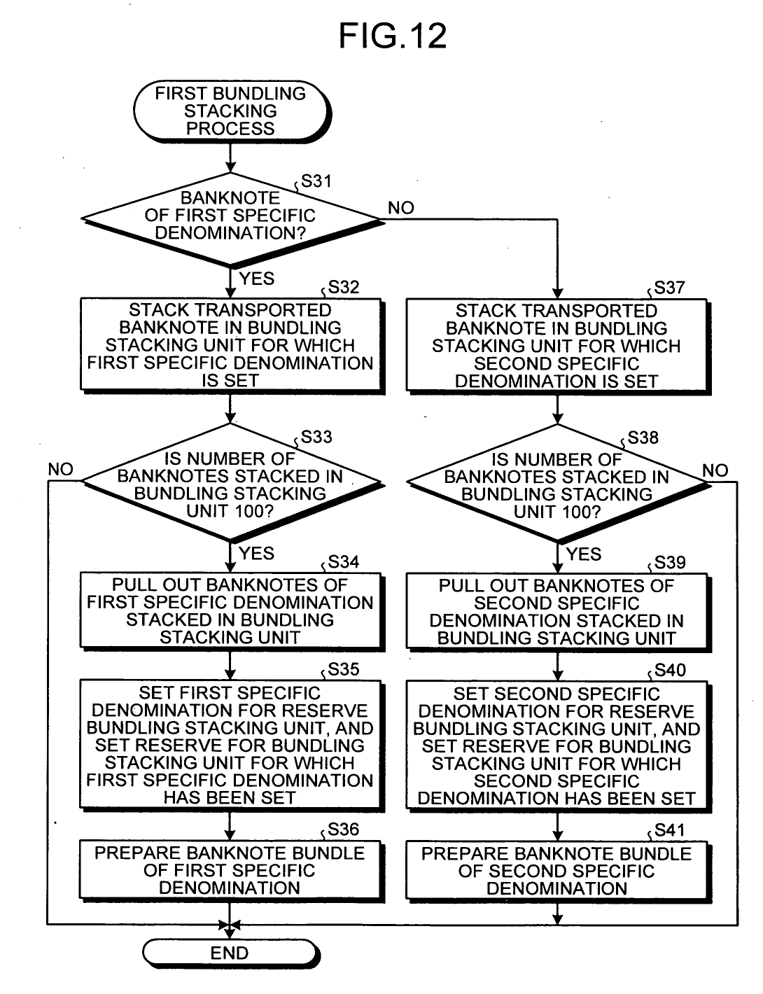

After transporting the fit banknote of the first specific denomination to the first bundling unit 3A, the control unit 170 goes to a first bundling stacking process illustrated in FIG. 12, which will be described later, (Step S15), and finishes the process operations illustrated in FIG. 11.

When the transported banknote is not a fit note (NO at Step S13), the transport control unit 172 determines that the transported banknote is an unfit note, and performs drive control on the banknote transport unit 13 and the diverter unit 13A via the drive control unit 150 (Step S16). Accordingly, the banknote transport unit 13 and the diverter unit 13A transport the unfit banknote of the first specific denomination, which is the transported banknote, to the bundling stacking unit 21 in the second bundling unit 3B (Step S16).

When the transported banknote is not of the first specific denomination (NO at Step S12), the control unit 170 determines whether the transported banknote is of the second specific denomination based on the recognition result (Step S17). When the transported banknote is of the second specific denomination (YES at Step S17), the control unit 170 determines whether the transported banknote is a fit note (Step S18).

When the transported banknote is a fit note (YES at Step S18), the transport control unit 172 goes to Step 5104 of M1 illustrated in the figure in order to transport the fit banknote of the second specific denomination to the first bundling unit 3A.

When the transported banknote is not a fit note (NO at Step S18), the transport control unit 172 determines that the transported banknote is an unfit note, and goes to Step S16 in order to transport the unfit banknote of the second specific denomination to the second bundling unit 3B.

When the transported banknote is not of the second specific denomination (NO at Step S17), the transport control unit 172 determines that the transported banknote is of a denomination other than the first specific denomination and the second specific denomination, and performs drive control on the banknote transport unit 13 and the diverter unit 13A via the drive control unit 150 (Step S19). Accordingly, the banknote transport unit 13 and the diverter unit 13A transport the transported banknote to the stacker 16 or the first rejection unit 17 corresponding to the banknote of the denomination other than the first specific denomination and the second specific denomination (Step S19), and finishes the process operations illustrated in FIG. 11.

The banknote processing apparatus 1 that performs the first specific denomination sorting process illustrated in FIG. 11 transports, both when a transported banknote is a fit note of the first specific denomination and when it is a fit note of the second specific denomination, the fit banknote of the first specific denomination and the fit banknote of the second specific denomination to the first bundling unit 3A. Accordingly, in the first bundling unit 3A, fit notes of the first specific denomination are stacked in the bundling stacking unit 21 corresponding to a fit note of the first specific denomination and fit notes of the second specific denomination are stacked in the bundling stacking unit 21 corresponding to a fit note of the second specific denomination.

The banknote processing apparatus 1 that performs the first specific denomination sorting process illustrated in FIG. 11 transports, both when a transported banknote is an unfit note of the first specific denomination and when it is an unfit note of the second specific denomination, the unfit banknote of the first specific denomination and the unfit banknote of the second specific denomination to the second bundling unit 3B. Accordingly, in the second bundling unit 3B, unfit notes of the first specific denomination are stacked in the bundling stacking unit 21 corresponding to an unfit note of the first specific denomination and unfit notes of the second specific denomination are stacked in the bundling stacking unit 21 corresponding to an unfit note of the second specific denomination.

The first bundling stacking process at Step S15 illustrated in FIG. 11 will be described below. FIG. 12 is a flowchart of internal process operations of the control unit 170 that engages in the first bundling stacking process. The first bundling stacking process illustrated in FIG. 12 is a process in which, in the case of the first bundling unit 3A, fit notes of the first specific denomination and fit notes of the second specific denominations, which are stacked in the bundling stacking unit 21, are bundled according to the specific denominations to prepare banknote bundles, and the banknote bundles are dispensed. The first bundling stacking process is a process in which, in the case of the second bundling unit 3B, unfit notes of the first specific denomination and unfit notes of the second specific denominations, which are stacked in the bundling stacking unit 21, are bundled according to the specific denominations to prepare banknote bundles, and the banknote bundles are dispensed.

In the process of FIG. 12, the control unit 170 determines whether the transported banknote, which has been transported by the banknote transport unit 13 and the diverter unit 13A, is of the first specific denomination (Step S31). When the transported banknote is of the first specific denomination (YES at Step S31), the transport control unit 172 in the control unit 170 stacks the transported banknote in the bundling stacking unit 21 for which the first specific denomination is set (Step S32). In the case of the first bundling unit 3A, the transported banknote determined at Step S31 corresponds to a fit banknote of the first specific denomination or a fit banknote of the second specific denomination. In the case of the second bundling unit 3B, the transported banknote determined at Step S31 corresponds to an unfit banknote of the first specific denomination or an unfit banknote of the second specific denomination. Furthermore, in the case of the first bundling unit 3A, the bundling stacking unit 21 in which the banknote is stacked at Step S32 corresponds to the bundling stacking unit 21 for which a fit banknote of the first specific denomination is set. In the case of the second bundling unit 3B, the bundling stacking unit 21 in which the banknote is stacked at Step S32 corresponds to the bundling stacking unit 21 for which an unfit banknote of the first specific denomination is set.

The transport control unit 172 determines whether the number of banknotes stacked in the bundling stacking unit 21, for which the first specific denomination is set, reaches 100 (Step S33). When the number of banknotes stacked in the bundling stacking unit 21, for which the first specific denomination is set, reaches 100 (YES at Step S33), the transport control unit 172 pulls out the 100 banknotes of the first specific denomination from the bundling stacking unit 21 via the pre-bundling transport unit 25 (Step S34).

After the 100 banknotes of the first specific denominations are pulled out from the bundling stacking unit 21 for which the first specific denomination is set, the setting control unit 171 in the control unit 170 sets the first specific denomination for the reserve bundling stacking unit 21 (Step S35). Further, the setting control unit 171 sets a reserve to the bundling stacking unit 21, for which the first specific denomination has been set and which is ready to stack banknotes because the banknotes have been pulled out (Step S35). In the case of the first bundling unit 3A, when fit banknotes of the first specific denomination are pulled out from the bundling stacking unit 21 for which a fit note of the first specific denomination is set, the setting control unit 171 sets a fit note of the first specific denomination for the reserve bundling stacking unit 21. Further, the setting control unit 171 sets a reserve to the bundling stacking unit 21, for which a fit note of the first specific denomination has been set and which is ready to stack banknotes because the fit banknotes have been pulled out. In the case of the second bundling unit 3B, when unfit banknotes of the first specific denomination are pulled out form the bundling stacking unit 21 for which an unfit note of the first specific denomination is set, the setting control unit 171 sets an unfit note of the first specific denomination for the reserve bundling stacking unit 21. Further, the setting control unit 171 sets a reserve for the bundling stacking unit 21, for which an unfit note of the first specific denomination has been set and which is ready to stack banknotes because the unfit banknotes have been pulled out.

The bundling control unit 173 winds a bundling band in the bundling position on the 100 pulled-out banknotes of the first specific denomination to prepare a banknote bundle of the first specific denomination (Step S36), and finishes the process operations illustrated in FIG. 12. Accordingly, the operator can obtain the banknote bundle of the fit notes of the first specific denomination. In the case of the first bundling unit 3A, the bundling control unit 173 sets the center portion of the fit banknotes of the first specific denomination to the bundling position, and winds the bundling band in the bundling position to prepare a center-bind banknote bundle of the fit notes of the first specific denomination. In the case of the second bundling unit 3B, the bundling control unit 173 sets the left end portion of the unfit banknotes of the first specific denomination to the bundling position, and winds a bundling band in the bundling position to prepare a left-end-bind banknote bundle of the unfit notes of the first specific denomination.

When the number of banknotes stacked in the bundling stacking unit 21, for which the first specific denomination is set, does not reach 100 (NO at Step S33), the transport control unit 172 finishes the process operations illustrated in FIG. 12.

When the transported banknote is not of the first specific denomination (NO at Step S31), the transport control unit 172 determines that the transported banknote is of the second specific denomination, and stacks the transported banknote in the bundling stacking unit 21 for which the second specific denomination is set (Step S37). In the case of the first bundling unit 3A, the transported banknote of the second specific denomination corresponds to a fit banknote of the second specific denomination. In the case of the second bundling unit 3B, the transported banknote of the second specific denomination corresponds to an unfit banknote of the second specific denomination. Furthermore, in the case of the first bundling unit 3A, the bundling stacking unit 21 in which the banknote is stacked at Step S37 corresponds to the bundling stacking unit 21 for which a fit note of the second specific denomination is set. In the case of the second bundling unit 3B, the bundling stacking unit 21 in which the banknote is stacked at Step S37 corresponds to the bundling stacking unit 21 for which an unfit note of the second specific denomination is set.

The transport control unit 172 determines whether the number of banknotes stacked in the bundling stacking unit 21, for which the second specific denomination is set, reaches 100 (Step S38). When the number of banknotes stacked in the bundling stacking unit 21, for which the second specific denomination is set, reaches 100 (YES at Step S38), the transport control unit 172 pulls out the 100 banknotes of the second specific denomination from the bundling stacking unit 21 via the pre-bundling transport unit 25 (Step S39).

After the 100 banknotes of the second specific denominations are pulled out from the bundling stacking unit 21 for which the second specific denomination is set, the setting control unit 171 in the control unit 170 sets the second specific denomination for the reserve bundling stacking unit 21 (Step S40). Further, the setting control unit 171 sets a reserve to the bundling stacking unit 21, for which the second specific denomination has been set and which is ready to stack banknotes because the banknotes have been pulled out (Step S40). In the case of the first bundling unit 3A, when fit banknotes of the second specific denomination are pulled out from the bundling stacking unit 21 for which a fit note of the second specific denomination is set, the setting control unit 171 sets a fit note of the second specific denomination for the reserve bundling stacking unit 21. Further, the setting control unit 171 sets a reserve to the bundling stacking unit 21, for which a fit note of the second specific denomination has been set and which is ready to stack banknotes because the fit banknotes have been pulled out. In the case of the second bundling unit 3B, when unfit banknotes of the second specific denomination are pulled out form the bundling stacking unit 21 for which an unfit note of the second specific denomination is set, the setting control unit 171 sets an unfit note of the second specific denomination for the reserve bundling stacking unit 21. Further, the setting control unit 171 sets a reserve for the bundling stacking unit 21, for which an unfit note of the second specific denomination has been set and which is ready to stack banknotes because the unfit banknotes have been pulled out.

The bundling control unit 173 winds a bundling band in the bundling position on the 100 pulled-out banknotes of the second specific denomination to prepare a banknote bundle of the second specific denomination (Step S41), and finishes the process operations illustrated in FIG. 12. Accordingly, the operator can obtain the banknote bundle of the fit notes of the second specific denomination. In the case of the first bundling unit 3A, the bundling control unit 173 sets the center portion of the fit banknotes of the second specific denomination to the bundling position, and winds the bundling band in the bundling position to prepare a center-bind banknote bundle of the fit notes of the second specific denomination. In the case of the second bundling unit 3B, the bundling control unit 173 sets the left end portion of the unfit banknotes of the second specific denomination to the bundling position, and winds a bundling band in the bundling position to prepare a left-end-bind banknote bundle of the unfit notes of the second specific denomination.

When the number of banknotes stacked in the bundling stacking unit 21, for which the second specific denomination is set, does not reach 100 (NO at Step S38), the transport control unit 172 finishes the process operations illustrated in FIG. 12.

The banknote processing apparatus 1 that performs the first bundling stacking process illustrated in FIG. 11 prepares a banknote bundle of fit notes of the first specific denomination when the number of fit banknotes of the first specific denomination, which are stacked in the bundling stacking unit 21 in the first bundling unit 3A, reaches 100. The banknote processing apparatus 1 that performs the first bundling stacking process prepares a banknote bundle of fit notes of the second specific denomination when the number of fit banknotes of the second specific denomination, which are stacked in the bundling stacking unit 21 in the first bundling unit 3A, reaches 100. Accordingly, the operator can collect the banknote bundle of the fit notes of the first specific denomination and the banknote bundle of the fit notes of the second specific denomination from the bundle dispensing port 23 of the first bundling unit 3A.

Furthermore, the banknote processing apparatus 1 that performs the first bundling stacking process prepares a banknote bundle of unfit notes of the first specific denomination when the number of unfit banknotes of the first specific denomination, which are stacked in the bundling stacking unit 21 in the second bundling unit 3B, reaches 100. The banknote processing apparatus 1 that performs the first bundling stacking process prepares a banknote bundle of unfit notes of the second specific denomination when the number of unfit banknotes of the second specific denomination, which are stacked in the bundling stacking unit 21 in the second bundling unit 3B, reaches 100. Accordingly, the operator can collect the banknote bundle of the unfit notes of the first specific denomination and the banknote bundle of the unfit notes of the second specific denomination from the bundle dispensing port 23 of the second bundling unit 3B.

In the first embodiment, a fit note of the first specific denomination and a fit note of the second specific denomination are set as stacked banknotes for the bundling stacking unit 21 in the first bundling unit 3A, and an unfit note of the first specific denomination and an unfit note of the second specific denomination are set as stacked banknotes for the bundling stacking unit 21 in the second bundling unit 3B. When a 50 Euro banknote is set for the first specific denomination and a 20 Euro banknote is set for the second specific denomination, 70% of the whole process for collecting and bundling Euro banknotes according to the denominations can be automated. Therefore, it is possible to significantly reduce an operational burden on the operator for collecting banknote bundles of fit 50 Euro banknotes, banknote bundles of fit 20 Euro banknotes, banknote bundles of unfit 50 Euro banknotes, and banknote bundles of unfit 20 Euro banknotes.

In the first embodiment, fit 50 Euro banknotes and fit 20 Euro banknotes are stacked in the bundling stacking unit 21 in the first bundling unit 3A, and unfit 50 Euro banknotes and unfit 20 Euro banknotes are stacked in the bundling stacking unit 21 in the second bundling unit 3B. Accordingly, the operator can collect banknote bundles of fit 20 Euro banknotes and banknote bundles of fit 50 Euro banknotes separately from banknote bundles of unfit 20 Euro banknotes and banknote bundles of unfit 50 Euro banknotes from the different bundle dispensing ports 23 via the first bundling unit 3A and the second bundling unit 3B. Therefore, a banknote bundle of fit notes of a specific denomination and a banknote bundle of unfit notes of a specific denomination can easily be distinguished.

In the first embodiment, three bundling stacking units 21 are provided in the first bundling unit 3A (3B), and banknotes of two specific denominations are respectively stacked in two bundling stacking units 21 out of the three bundling stacking units 21. Therefore, according to the first embodiment, one first bundling unit 3A (3B) can collect banknote bundles of fit notes and banknote bundles of unfit notes according to specific denominations in various patterns. For example, one first bundling unit 3A (3B) can collect banknote bundles of fit notes of one specific denomination and banknote bundles of unfit notes of the same specific denomination, collect banknote bundles of fit notes of two specific denominations or banknote bundles of unfit notes of two specific denominations, or collect banknote bundles of fit notes of two specific denominations and banknote bundles of unfit notes of two specific denominations.

Furthermore, in the first embodiment, the bundling position of the bundling band is changed depending on the fitness categories. For example, the bundling band is wound around the center portion of a banknote bundle of fit notes and wound around the left end of the banknote bundle of unfit notes so that the fit notes of the specific denomination and the unfit notes of the specific denomination can be distinguished. Accordingly, the operator can distinguish between the banknote bundle of the fit notes of the specific denomination and the banknote bundle of the unfit notes of the specific denomination by the bundling position of the bundling band.

### Second Embodiment

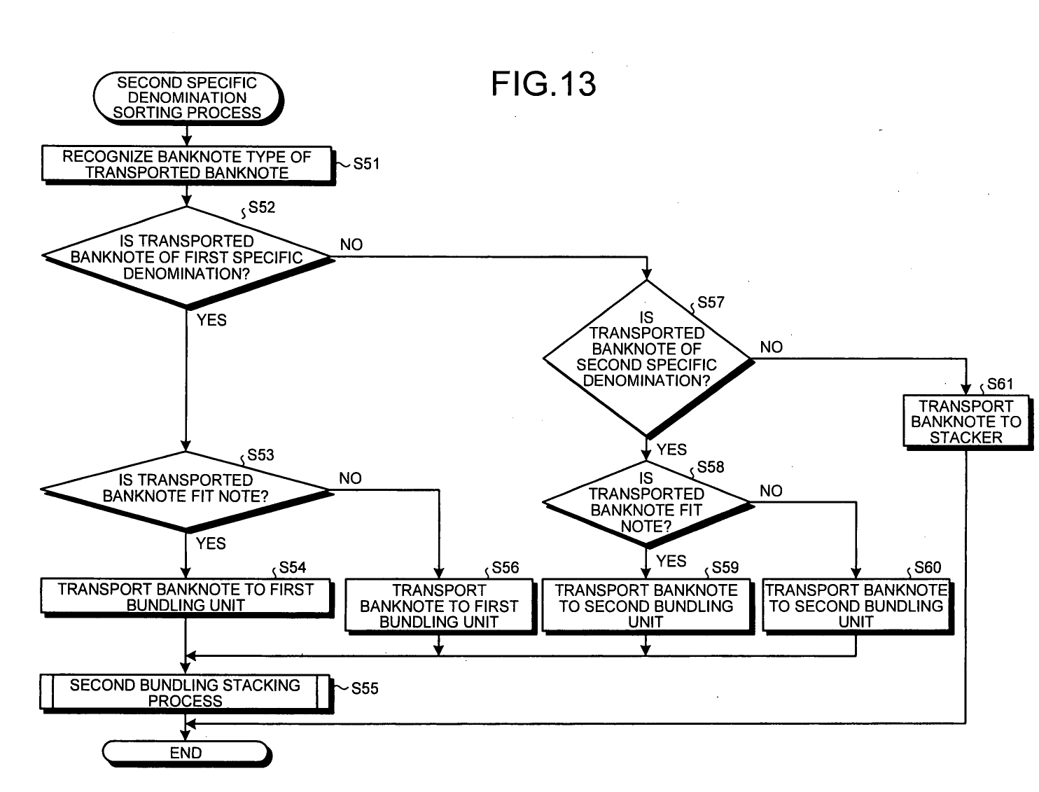

A fit note of the first specific denomination and an unfit note of the first specific denomination may be set as stacked banknotes for the first bundling unit 3A, and a fit note of the second specific denomination and an unfit note of the second specific denomination may be set as stacked banknotes for the second bundling unit 3B. This will be described below as a second embodiment. FIG. 13 is a flow chart of internal process operations of the control unit 170 that engages in a second specific denomination sorting process. The second specific denomination sorting process illustrated in FIG. 13 is a process in which transported banknotes being fit notes of the first specific denomination and unfit notes of the first specific denomination are sorted in the first bundling unit 3A, and transported banknotes being fit notes of the second specific denomination and unfit notes of the second specific denomination are sorted in the second bundling unit 3B. As illustrated in FIG. 5(B), the setting control unit 171 in the control unit 170 sets a fit note of the first specific denomination and an unfit note of the first specific denomination as stacked banknotes for the first bundling unit 3A, and sets a fit note of the second specific denomination and an unfit note of the second specific denomination as stacked banknotes for the second bundling unit 3B. For example, the setting control unit 171 sets, in the case of Euro banknotes, a 50 Euro banknote for the first specific denomination and a 20 Euro banknote for the second specific denomination.

The control unit 170 recognizes the banknote type of a transported banknote via the banknote recognition unit 14 (Step S51), and determines whether the transported banknote is of the first specific denomination based on the recognition result (Step S52).

When the transported banknote is of the first denomination (YES at Step S52), the control unit 170 determines whether the transported banknote is a fit note based on the recognition result (Step S53). When the transported banknote is a fit note (YES at Step S53), the transport control unit 172 in the control unit 170 performs drive control on the banknote transport unit 13 and the diverter unit 13A via the drive control unit 150 (Step S54). Accordingly, the banknote transport unit 13 and the diverter unit 13A transport the fit note of the first specific denomination, which is the transported banknote, to the bundling stacking unit 21 in the first bundling unit 3A (Step S54).

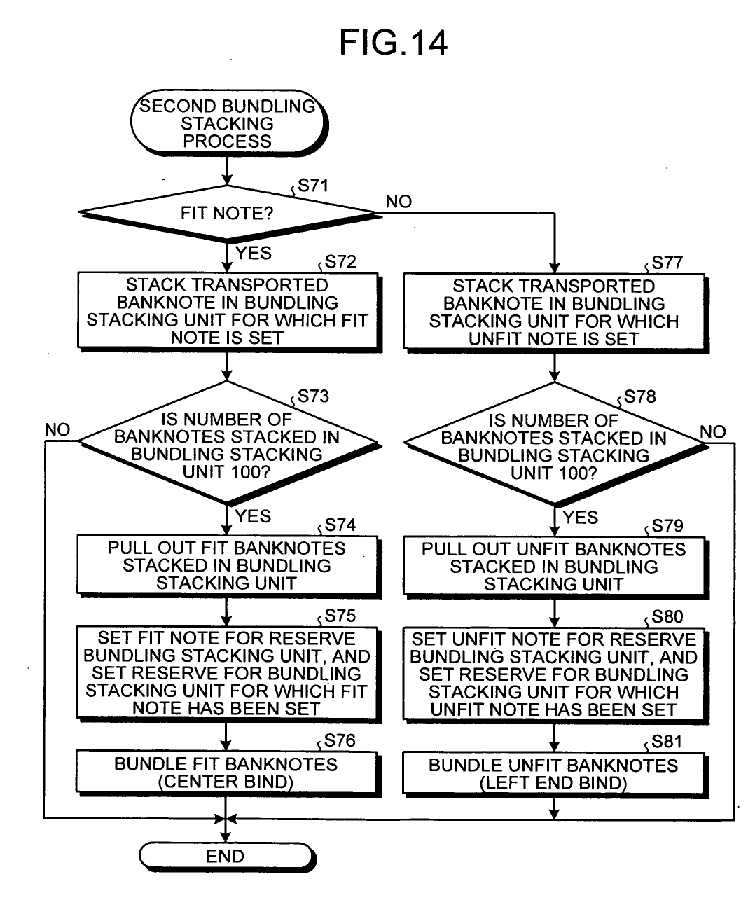

After transporting the fit banknote of the first specific denomination to the first bundling unit 3A, the control unit 170 goes to a second bundling stacking process illustrated in FIG. 14, which will be described later (Step S55), and finishes the process operations illustrated in FIG. 13.

When the transported banknote is not a fit note (NO at Step S53), the transport control unit 172 determines that the transported banknote is an unfit note, and performs drive control on the banknote transport unit 13 and the diverter unit 13A via the drive control unit 150 (Step S56). Accordingly, the banknote transport unit 13 and the diverter unit 13A transport the unfit banknote of the first specific denomination, which is the transported banknote, to the bundling stacking unit 21 in the first bundling unit 3A (Step S56), and the process goes to the second bundling stacking process at Step S55.

When the transported banknote is not of the first specific denomination (NO at Step S52), the control unit 170 determines whether the transported banknote is of the second specific denomination based on the recognition result (Step S57). When the transported banknote is of the second specific denomination (YES at Step S57), the control unit 170 determines whether the transported banknote is a fit note (Step S58).

When the transported banknote is a fit note (YES at Step S58), the transport control unit 172 performs drive control on the banknote transport unit 13 and the diverter unit 13A via the drive control unit 150 (Step S59). Accordingly, the banknote transport unit 13 and the diverter unit 13A transport the fit banknote of the second specific denomination, which is the transported banknote, to the bundling stacking unit 21 in the second bundling unit 3B (Step S59), and the process goes to the second bundling stacking process at Step S55.

When the transported banknote is not a fit note (NO at Step S58), the transport control unit 172 determines that the transported banknote is an unfit note, and performs drive control on the banknote transport unit 13 and the diverter unit 13A via the drive control unit 150 (Step S60). Accordingly, the banknote transport unit 13 and the diverter unit 13A transport the unfit banknote of the second specific denomination, which is the transported banknote, to the bundling stacking unit 21 in the second bundling unit 3B (Step S60), and the process goes to the second bundling stacking process at Step S55.

When the transported banknote is not of the second specific denomination (NO at Step S57), the transport control unit 172 determines that the transported banknote is of a denomination other than the first specific denomination and the second specific denomination, and performs drive control on the banknote transport unit 13 and the diverter unit 13A via the drive control unit 150 (Step S61). Accordingly, the banknote transport unit 13 and the diverter unit 13A transport the transported banknote to the stacker 16 or the first rejection unit 17 corresponding to the banknote of the denomination other than the first specific denomination and the second specific denomination, i.e., corresponding to the transported banknote (Step S61), and finishes the process operations illustrated in FIG. 13.

The banknote processing apparatus 1 that performs the second specific denomination sorting process illustrated in FIG. 13 transports, both when the transported banknote is a fit banknote of the first specific denomination and when it is an unfit banknote of the first specific denomination, the fit banknote of the first specific denomination and the unfit banknote of the first specific denomination to the banknote bundling unit 3. Accordingly, in the first bundling unit 3A, fit banknotes of the first specific denomination are stacked in the bundling stacking unit 21 corresponding to a fit note of the first specific denomination, and unfit banknotes of the first specific denomination are stacked in the bundling stacking unit 21 corresponding to an unfit note of the first specific denomination.

The banknote processing apparatus 1 that performs the second specific denomination sorting process illustrated in FIG. 13 transports, both when the transported banknote is a fit banknote of the second specific denomination and when it is an unfit banknote of the second specific denomination, the fit banknote of the second specific denomination and the unfit banknote of the second specific denomination to the second bundling unit 3B. Accordingly, in the second bundling unit 3B, fit banknotes of the second specific denomination are stacked in the bundling stacking unit 21 corresponding to a fit note of the second specific denomination and unfit banknotes of the second specific denomination are stacked in the bundling stacking unit 21 corresponding to an unfit note of the second specific denomination.

The second bundling stacking process at Step S55 illustrated in FIG. 13 will be described below. FIG. 14 is a flowchart of internal process operations of the control unit 170 that engages in the second bundling stacking process according to the second embodiment. The second bundling stacking process illustrated in FIG. 14 is a process in which, in the case of the first bundling unit 3A, fit notes of the first specific denomination and unfit notes of the first specific denominations, which are stacked in the bundling stacking unit 21, are bundled according to the fitness categories to prepare banknote bundles, and the banknote bundles are dispensed. The second bundling stacking process is a process in which, in the case of the second bundling unit 3B, fit notes of the second specific denomination and unfit notes of the second specific denominations, which are stacked in the bundling stacking unit 21, are bundled according to the fitness categories to prepare banknote bundles, and the banknote bundles are dispensed.

In the process of FIG. 14, the control unit 170 determines whether the transported banknote, which has been transported by the banknote transport unit 13 and the diverter unit 13A, is a fit note (Step S71). When the transported banknote is a fit note (YES at Step S71), the transport control unit 172 in the control unit 170 stacks the transported banknote in the bundling stacking unit 21 for which a fit note is set (Step S72). In the case of the first bundling unit 3A, the transported banknote determined at Step S71 corresponds to a fit banknote of the first specific denomination or an unfit banknote of the first specific denomination. In the case of the second bundling unit 3B, the transported banknote determined at Step S71 corresponds to a fit banknote of the second specific denomination or an unfit banknote of the second specific denomination. Furthermore, in the case of the first bundling unit 3A, the bundling stacking unit 21 in which the banknote is stacked at Step S72 corresponds to the bundling stacking unit 21 for which a fit banknote of the first specific denomination is set. In the case of the second bundling unit 3B, the bundling stacking unit 21 in which the banknote is stacked at Step S72 corresponds to the bundling stacking unit 21 for which a fit banknote of the second specific denomination is set.

The transport control unit 172 determines whether the number of banknotes stacked in the bundling stacking unit 21, for which the fit note is set, reaches 100 (Step S73). When the number of banknotes stacked in the bundling stacking unit 21, for which the fit note is set, reaches 100 (YES at Step S73), the transport control unit 172 pulls out the 100 fit banknotes from the bundling stacking unit 21 via the pre-bundling transport unit 25 (Step S74).

After the 100 fit banknotes are pulled out from the bundling stacking unit 21 for which the fit note is set, the setting control unit 171 in the control unit 170 sets a fit note for the reserve bundling stacking unit 21 (Step S75). Further, the setting control unit 171 sets a reserve to the bundling stacking unit 21, for which the fit note has been set and which is ready to stack banknotes because the banknotes have been pulled out (Step S75). In the case of the first bundling unit 3A, when fit banknotes of the first specific denomination are pulled out from the bundling stacking unit 21 for which a fit note of the first specific denomination is set, the setting control unit 171 sets a fit note of the first specific denomination for the reserve bundling stacking unit 21. Further, the setting control unit 171 sets a reserve to the bundling stacking unit 21, for which a fit note of the first specific denomination has been set and which is ready to stack banknotes because the fit banknotes of the first specific denomination have been pulled out. In the case of the second bundling unit 3B, when fit banknotes of the second specific denomination are pulled out form the bundling stacking unit 21 for which a fit note of the second specific denomination is set, the setting control unit 171 sets a fit note of the second specific denomination for the reserve bundling stacking unit 21. Further, the setting control unit 171 sets a reserve for the bundling stacking unit 21, for which a fit note of the second specific denomination has been set and which is ready to stack banknotes because the fit banknotes of the second specific denomination have been pulled out.

The bundling control unit 173 winds a bundling band in the bundling position on the 100 pulled-out fit banknotes of the first specific denomination to prepare a banknote bundle of the fit banknotes of the first specific denomination (Step S76), and finishes the process operations illustrated in FIG. 14. Accordingly, the operator can obtain the banknote bundle of the fit notes of the first specific denomination. In the case of the first bundling unit 3A, the bundling control unit 173 sets the center portion of the fit banknotes of the first specific denomination to the bundling position, and winds the bundling band in the bundling position to prepare a center-bind banknote bundle of the fit notes of the first specific denomination. In the case of the second bundling unit 3B, the bundling control unit 173 sets the center portion of the fit banknotes of the second specific denomination to the bundling position, and winds a bundling band in the bundling position to prepare a center-bind banknote bundle of the fit notes of the second specific denomination.

When the number of banknotes stacked in the bundling stacking unit 21, for which the fit banknote is set, does not reach 100 (NO at Step S73), the transport control unit 172 finishes the process operations illustrated in FIG. 14.

When the transported banknote is not a fit note (NO at Step S71), the transport control unit 172 determines that the transported banknote is an unfit note, and stacks the transported banknote in the bundling stacking unit 21 for which an unfit note is set (Step S77). In the case of the first bundling unit 3A, the transported banknote corresponds to an unfit banknote of the first specific denomination. In the case of the second bundling unit 3B, the transported banknote corresponds to an unfit banknote of the second specific denomination. Furthermore, in the case of the first bundling unit 3A, the bundling stacking unit 21 in which the banknote is stacked at Step S77 corresponds to the bundling stacking unit 21 for which an unfit note of the first specific denomination is set. In the case of the second bundling unit 3B, the bundling stacking unit 21 in which the banknote is stacked at Step S77 corresponds to the bundling stacking unit 21 for which an unfit note of the second specific denomination is set.

The transport control unit 172 determines whether the number of banknotes stacked in the bundling stacking unit 21, for which an unfit note is set, reaches 100 (Step S78). When the number of banknotes stacked in the bundling stacking unit 21, for which an unfit note is set, reaches 100 (YES at Step S78), the transport control unit 172 pulls out the 100 unfit banknotes from the bundling stacking unit 21 via the pre-bundling transport unit 25 (Step S79).

When the 100 unfit banknotes are pulled out from the bundling stacking unit 21 for which an unfit note is set, the setting control unit 171 in the control unit 170 sets an unfit note for the reserve bundling stacking unit 21 (Step S80). Further, the setting control unit 171 sets a reserve to the bundling stacking unit 21, for which an unfit note has been set and which is ready to stack banknotes because the banknotes have been pulled out (Step S80). In the case of the first bundling unit 3A, when unfit banknotes of the first specific denomination are pulled out from the bundling stacking unit 21 for which an unfit note of the first specific denomination is set, the setting control unit 171 sets an unfit note of the first specific denomination for the reserve bundling stacking unit 21. Further, the setting control unit 171 sets a reserve to the bundling stacking unit 21, for which an unfit note of the second specific denomination has been set and which is ready to stack banknotes because the unfit banknotes have been pulled out. In the case of the second bundling unit 33, when unfit banknotes of the second specific denomination are pulled out form the bundling stacking unit 21 for which an unfit note of the second specific denomination is set, the setting control unit 171 sets an unfit note of the second specific denomination for the reserve bundling stacking unit 21. Further, the setting control unit 171 sets a reserve for the bundling stacking unit 21, for which an unfit note of the second specific denomination has been set and which is ready to stack banknotes because the unfit banknotes have been pulled out.

The bundling control unit 173 winds a bundling band in the bundling position on the left end portion of the 100 pulled-out unfit banknotes to prepare a banknote bundle of unfit notes (Step S81), and finishes the process operations illustrated in FIG. 14. Accordingly, the operator can obtain the banknote bundle of the unfit notes. In the case of the first bundling unit 3A, the bundling control unit 173 sets the left end portion of the unfit banknotes of the first specific denomination to the bundling position, and winds the bundling band in the bundling position to prepare a left-end-bind banknote bundle of the unfit notes of the first specific denomination. In the case of the second bundling unit 3B, the bundling control unit 173 sets the left end portion of the unfit banknotes of the second specific denomination to the bundling position, and winds a bundling band in the bundling position to prepare a left-end-bind banknote bundle of the unfit notes of the second specific denomination.

When the number of banknotes stacked in the bundling stacking unit 21, for which an unfit note is set, does not reach 100 (NO at Step S78), the transport control unit 172 finishes the process operations illustrated in FIG. 14.

The banknote processing apparatus 1 that performs the second bundling stacking process illustrated in FIG. 14 prepares a banknote bundle of fit notes of the first specific denomination when the number of fit banknotes of the first specific denomination, which are stacked in the bundling stacking unit 21 in the first bundling unit 3A, reaches 100. The banknote processing apparatus 1 that performs the second bundling stacking process prepares a banknote bundle of unfit notes of the first specific denomination when the number of unfit banknotes of the first specific denomination, which are stacked in the bundling stacking unit 21 in the first bundling unit 3A, reaches 100. Accordingly, the operator can collect the banknote bundle of the fit notes of the first specific denomination and the banknote bundle of the unfit notes of the first specific denomination from the bundle dispensing port 23 of the first bundling unit 3A.

Furthermore, the banknote processing apparatus 1 that performs the second bundling stacking process prepares a banknote bundle of fit notes of the second specific denomination when the number of fit banknotes of the second specific denomination, which are stacked in the bundling stacking unit 21 in the second bundling unit 3B, reaches 100. The banknote processing apparatus 1 that performs the second bundling stacking process prepares a banknote bundle of unfit notes of the second specific denomination when the number of unfit banknotes of the second specific denomination, which are stacked in the bundling stacking unit 21 in the second bundling unit 3B, reaches 100. Accordingly, the operator can collect the banknote bundle of the fit notes of the second specific denomination and the banknote bundle of the unfit notes of the second specific denomination from the bundle dispensing port 23 of the second bundling unit 3B.

In the second embodiment, a fit note of the first specific denomination and an unfit note of the first specific denomination are set as stacked banknotes for the bundling stacking unit 21 in the first bundling unit 3A, and a fit note of the second specific denomination and an unfit note of the second specific denomination are set as stacked banknotes for the bundling stacking unit 21 in the second bundling unit 3B. When a 50 Euro banknote is set for the first specific denomination and a 20 Euro banknote is set for the second specific denomination, it is possible to automate 70% of the whole process for collecting and bundling Euro banknotes according to the denominations. Therefore, it is possible to significantly reduce an operational burden on the operator for collecting banknote bundles of fit 50 Euro banknotes, banknote bundles of fit 20 Euro banknotes, banknote bundles of unfit 50 Euro banknotes, and banknote bundles of unfit 20 Euro banknotes.

In the second embodiment, three bundling stacking units 21 are provided in the first bundling unit 3A (3B), and banknotes of two specific denominations are respectively stacked in two bundling stacking units 21 out of the three bundling stacking units 21. Therefore, according to the second embodiment, it is possible to successively collect banknote bundles of two specific denominations.

In the second embodiment, a 50 Euro banknote is set for the first specific denomination, a 20 Euro banknote is set for the second specific denomination. A fit 50 Euro banknote and an unfit 50 Euro banknote are set for the bundling stacking units 21 in the first bundling unit 3A. Furthermore, in the second embodiment, a fit 20 Euro banknote and an unfit 20 Euro banknote are set for the bundling stacking units 21 in the second bundling unit 3B. According to the second embodiment, because a fit note and an unfit note of identical specific denominations can be set for the single first bundling unit 3A (3B), the present invention is applicable to the operations on U.S. Dollar banknotes for which it is provided that the banknotes need to be bundled with a bundling band of a different color according to the specific denominations. In this case, in the banknote processing apparatus 1, assuming that a 20 U.S. Dollar banknote is set for the first specific denomination and a 10 U.S. Dollar banknote is set for the second specific denomination, a fit 20 U.S. Dollar banknote and an unfit 20 U.S. Dollar banknote are set for the bundling stacking unit 21 in the first bundling unit 3A. As illustrated in FIG. 5(C), the bundling unit 22 in the first bundling unit 3A bundles fit 20 U.S. Dollar banknotes and unfit 20 U.S. Dollar banknotes with orange bundling bands. Furthermore, in the banknote processing apparatus 1, a fit 10 U.S. Dollar banknote and an unfit 10 U.S. Dollar banknote is set for the bundling stacking unit 21 in the second bundling unit 3B. The bundling unit 22 in the second bundling unit 3B bundles fit 10 U.S. Dollar banknotes and unfit 10 U.S. Dollar banknotes with blue bundling bands. Accordingly, the operator can fully conform with the practice of U.S. Dollar banknotes.

In the first and second embodiments, a banknote bundle of fit banknotes with a band on the center of the banknote bundle and a banknote bundle of unfit banknotes with a band on the left end of the banknote bundle are dispensed. However, the bundling position where the bundling band is wound can appropriately be changed by adjusting the bundling position on the to-be-bundled-banknotes via the grip transport unit 27.

Furthermore, in the first and second embodiments, the bundling positions are changed so that a banknote bundle of fit notes and a banknote bundle of unfit notes to be dispensed from the same bundle dispensing port 23 can be distinguished from each other. However, it is possible to distinguish between the fit notes and the unfit notes by printing different contents on the bundling bands by the printing unit 56 without changing the bundling positions.

Moreover, in the first and second embodiments, it is possible to wind a bundling band on one portion of fit notes and wind bundling bands on two portions of unfit notes in order to distinguish between the fit notes and the unfit notes.

In the first and second embodiments, the bundling stacking unit 21 is three-layered in the banknote bundling unit 3. However, the bundling stacking unit 21 is not limited to the three-layered, and may be multiple-layered. In the first and second embodiments, the banknote bundling unit 3 is two-layered in which the first bundling unit 3A and the second bundling unit 3B are connected. However, the banknote bundling unit 3 is not limited to the two-layered, and may be multiple-layered. For example, in the banknote processing apparatus 1, a 50 Euro banknote is set for the bundling stacking unit 21 in the first bundling unit 3A, a 20 Euro banknote is set for the bundling stacking unit 21 in the second bundling unit 3B, and a 10 Euro banknote is set for the bundling stacking unit 21 in a third bundling unit. Accordingly, because operations of collecting banknote bundles of fit banknotes and unfit banknotes of three denominations are automated, the banknote processing apparatus 1 can perform most of the banknote processing operations related to Euro banknotes, enabling to significantly reduce an operational burden on the operator.

In the embodiments, descriptions are provided taking, as an example, the banknote bundling unit 3 that bundles to-be-bundled-banknotes with a bundling band. Similar effects can be obtained in a case where banknotes, such as gift vouchers or valuable securities, are bundled with a bundling band.

Among the processes described in the embodiments, the processes that are described as those automatically performed may be entirely or partially performed manually and the processes that are described as those manually performed may be entirely or partially performed automatically. In addition, the process procedures, control procedures, specific names, information including various types of data and parameters that are illustrated in the embodiments may be changed arbitrarily unless otherwise noted.

The components of each device illustrated in the drawings are not necessarily required to be physically configured as illustrated in the drawings. In other words, the specific modes of separation or integration of the components are not limited to those illustrated in the drawings. The components may be configured in a way that they are entirely or partially separated or integrated functionally or physically on an arbitrary basis in accordance with various loads or how they are used. For example, the drive control unit 150 and the size adjustment drive control unit 160 may be integrated into a single unit. Among the processes described in the embodiments, the processes that are described as those automatically performed may be entirely or partially performed manually.

In the banknote processing apparatus according to the present invention with the above-described configuration, fit notes of a plurality of specific denominations are stacked in stacking bundling units corresponding to fit notes of the respective specific denominations, and unfit notes of a plurality of specific denominations are stacked in stacking bundling units corresponding to unfit notes of the respective specific denominations. Accordingly, an operational burden on the operator when collecting banknote bundles of fit notes of the specific denominations and banknote bundles of unfit notes of the specific denominations can significantly be reduced.

In the banknote processing apparatus according to the present invention, in addition to the above-described effects of the present invention, fit notes of a specific denomination and unfit notes of a specific denomination are bundled so that a bundle of the fit notes and a bundle of the unfit notes can be distinguished from each other. Accordingly, the operator can distinguish between the banknote bundle of the fit notes of the specific denomination and the banknote bundle of the unfit notes of the specific denomination.

In the banknote processing apparatus according to the present invention, in addition to the above-described effects of the present invention, fit banknotes of specific denominations are stacked in bundling stacking units in one banknote bundling unit out of a plurality of banknote bundling units, and unfit banknotes of the specific denominations are stacked in bundling stacking units in another banknote bundling unit out of the banknote bundling units. Accordingly, the operator can collect banknote bundles of fit notes of the specific denomination and banknote bundles of unfit notes of the specific denomination from different banknote bundling units. Therefore, the banknote bundles of the fit notes of the specific denomination and the banknote bundles of the unfit notes of the specific denomination can be distinguished from each other.

In the banknote processing apparatus according to the present invention, in addition to the above-described effects of the present invention, three bundling stacking units are provided in a banknote bundling unit, and banknotes of two specific denominations are respectively stacked in two bundling stacking units out of the three bundling stacking units. Accordingly, in the banknote processing apparatus of the present invention, one banknote bundling unit can collect banknote bundles of fit notes and unfit notes according to specific denominations in various patterns. For example, one banknote bundling unit can collect banknote bundles of fit notes and banknote bundles of unfit notes of one specific denomination, collect banknote bundles of fit notes of two specific denominations or banknote bundles of unfit notes of two specific denominations, or collect banknote bundles of fit notes of two specific denominations and banknote bundles of unfit notes of two specific denominations. In the banknote processing apparatus of the present invention, every time the number of banknotes stacked in any one of the bundling stacking units reaches a predetermined number, a banknote stacking destination for the specific denomination, which is the denomination of the banknotes that have been stacked in the one of the bundling stacking units, is sequentially switched to a reserve bundling stacking unit. Accordingly, in the banknote processing apparatus of the present invention, it is possible to stack banknotes of a specific denomination without stopping the stacking operation.

In the banknote processing apparatus according to the present invention, in addition to the above-described effects of the present invention, the bundling position of the bundling band is changed according to each fitness category to prepare a banknote bundle of fit notes of a specific denomination and a banknote bundle of unfit notes of a specific denomination so that the banknote bundles can be distinguished from each other. Accordingly, the operator can distinguish between the banknote bundle of the fit notes of the specific denomination and the banknote bundle of the unfit notes of the specific denomination based on the bundling position of the bundling band.

In the banknote processing apparatus according to the present invention, in addition to the above-described effects of the present invention, contents to be printed on a bundling band is changed according to each fitness category to prepare a banknote bundle of fit notes of a specific denomination and a banknote bundle of unfit notes of a specific denomination so that the banknote bundles can be distinguished from each other. Accordingly, the operator can distinguish between the banknote bundle of the fit notes of the specific denomination and the banknote bundle of the unfit notes of the specific denomination based on the information printed on the bundling band.

In the banknote processing apparatus according to the present invention, in addition to the above-described effects of the present invention, fit banknotes of one specific denomination out of specific denominations are stacked in a bundling stacking unit in one of a plurality of banknote bundling units, and unfit notes of the same specific denomination are stacked in another bundling stacking unit in the same banknote bundling unit. Accordingly, the banknote processing apparatus of the present invention can collect banknote bundles of fit notes of the specific denomination and banknote bundles of unfit notes of the same specific denomination in the bundling stacking units in the same banknote bundling unit.

In the banknote processing apparatus according to the present invention, in addition to the above-described effects of the present invention, the banknote bundling unit includes three bundling stacking units, and fit banknotes of one specific denomination and unfit banknotes of the same specific denomination are respectively stacked in two bundling stacking units out of the three bundling stacking units. Accordingly, the banknote processing apparatus of the present invention can successively collect banknote bundles of fit notes and banknote bundles of unfit notes of one specific denomination. In the banknote processing apparatus of the present invention, every time the number of banknotes stacked in any one of the bundling stacking units reaches a predetermined number, a banknote stacking destination for the type, which is the type of the banknotes that have been stacked in the one of the bundling stacking units, is sequentially switched to a reserve stacking bundling unit. Accordingly, the banknote processing apparatus of the present invention can stack fit notes and unfit notes of one specific denomination without stopping a stacking operation.

In the banknote processing apparatus according to the present invention, in addition to the above-described effects of the present invention, the color of a bundling band is changed according to different specific denominations so that banknote bundles can be distinguished according to each specific denomination. Accordingly, the operator can fully conform with the practice of, for example, U.S. Dollar banknotes.

In a banknote sorting method according to the present invention with the above-described configuration, fit banknotes of a plurality of specific denominations are stacked in bundling stacking units corresponding to fit notes of the specific denominations, and unfit banknotes of a plurality of specific denominations are stacked in bundling stacking units corresponding to unfit notes of the specific denominations. Accordingly, it is possible to reduce an operational burden on the operator when collecting banknote bundles of fit notes of a plurality of specific denominations and banknote bundles of unfit notes of a plurality of specific denominations.

In a computer readable recording medium which stores a banknote sorting program according to the present invention with the above-described configuration, fit banknotes of a plurality of specific denominations are stacked in bundling stacking units corresponding to fit notes of the specific denominations, and unfit banknotes of a plurality of specific denominations are stacked in bundling stacking units corresponding to unfit notes of the specific denominations. Accordingly, it is possible to reduce an operational burden on the operator when collecting banknote bundles of fit notes of a plurality of specific denominations and banknote bundles of unfit notes of a plurality of specific denominations.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A banknote processing apparatus comprising:
a transport unit for feeding inserted banknotes one by one and transporting the banknotes;
a recognition unit for recognizing denominations of the banknotes fed by the transport unit, and recognizing a degree of stain on the banknotes, the denominations of which have been recognized, according to two fitness categories of a fit note and an unfit note;
a plurality of banknote bundling units, each of which includes:
a plurality of bundling stacking units for stacking the banknotes recognized by the recognition unit to bundle the banknotes;
a bundling unit for bundling a predetermined number of banknotes stacked in the bundling stacking units to prepare a banknote bundle; and
a bundle dispensing unit for dispensing the banknote bundle prepared by the bundling unit to the outside of the apparatus; and
a control unit for recognizing fit notes and unfit notes of a plurality of specific denominations via the recognition unit, and controlling the transport unit to stack fit banknotes of the specific denominations in bundling stacking units corresponding to fit notes of the specific denominations and stack unfit banknotes of the specific denominations in bundling stacking units corresponding to unfit notes of the specific denominations.

2. The banknote processing apparatus according to claim 1, wherein
the control unit is configured to control the bundling unit to prepare bundles of fit banknotes of the specific denominations and bundles of unfit banknotes of the specific denominations so that the bundles can be distinguished from each other.

3. The banknote processing apparatus according to claim 1, wherein
the control unit is configured to control the transport unit to stack fit banknotes of the specific denominations in bundling stacking units in one banknote bundling unit out of the banknote bundling units and stack unfit banknotes of the specific denominations in bundling stacking units in another banknote bundling unit out of the banknote bundling units.

4. The banknote processing apparatus according to claim 3, wherein
each of the banknote bundling units includes three bundling stacking units, and
the control unit is configured to control the transport unit to stack banknotes of two specific denominations in respective two bundling stacking units out of the three bundling stacking units, and, every time the number of banknotes stacked in any one of the bundling stacking units reaches a predetermined number, sequentially switch a banknote stacking destination for the specific denomination, which is a denomination of the banknotes that have been stacked in the one of the bundling stacking units, to a reserve bundling stacking unit.

5. The banknote processing apparatus according to claim 1, wherein
the control unit is configured to control the bundling unit to change a bundling position of a bundling band according to the fitness categories to prepare bundles of fit banknotes of the specific denominations and bundles of unfit banknotes of the specific denominations so that the bundles can be distinguished from each other.

6. The banknote processing apparatus according to claim 1, wherein
the control unit is configured to control the bundling unit to change contents to be printed on a bundling band according to the fitness categories to prepare bundles of fit banknotes of the specific denominations and bundles of unfit banknotes of the specific denominations so that the bundles can be distinguished from each other.

7. The banknote processing apparatus according to claim 1, wherein
the control unit is configured to control the transport unit to stack fit banknotes of one denomination out of the specific denominations in a stacking bundling unit in one of the banknote bundling units, and stack unfit banknotes of the same denomination out of the specific denominations in another bundling stacking unit in the same banknote bundling unit.

8. The banknote processing apparatus according to claim 7, wherein
each of the banknote bundling units includes three bundling stacking units, and
the control unit is configured to control the transport unit to stack fit banknotes of one specific denomination and unfit banknotes of the same specific denomination in respective two bundling stacking units out of the three bundling stacking units, and, every time the number of banknotes stacked in any one of the bundling stacking units reaches a predetermined number, sequentially switch a banknote stacking destination for a type, which is a type of the banknotes that have been stacked in the one of the bundling stacking units, to a reserve bundling stacking unit.

9. The banknote processing apparatus according to claim 7, wherein
the control unit is configured to control the bundling unit to change a color of a bundling band according to the specific denominations so that banknote bundles of the respective specific denominations can be distinguished from each other.

10. A banknote sorting method for a banknote processing apparatus that includes a transport unit for feeding inserted banknotes one by one and transporting the banknotes, a recognition unit for recognizing denominations of the banknotes fed by the transport unit, and recognizing a degree of stain on the banknotes, the denominations of which have been recognized, according to two fitness categories of a fit note and an unfit note, and a plurality of banknote bundling units, each of which includes a plurality of bundling stacking units for stacking the banknotes recognized by the recognition unit to bundle the banknotes, a bundling unit for bundling a predetermined number of banknotes stacked in the bundling stacking units to prepare a banknote bundle, and a bundle dispensing unit for dispensing the banknote bundle prepared by the bundling unit to the outside of the apparatus,
the banknote sorting method comprising:
recognizing fit notes and unfit notes of a plurality of specific denominations via the recognition unit; and
controlling the transport unit to stack fit banknotes of the specific denominations in bundling stacking units corresponding to fit notes of the specific denominations and stack unfit banknotes of the specific denominations in bundling stacking units corresponding to unfit notes of the specific denominations.

11. A computer readable recording medium which stores a banknote sorting program for a banknote processing apparatus that includes a transport unit for feeding inserted banknotes one by one and transporting the banknotes, a recognition unit for recognizing denominations of the banknotes fed by the transport unit, and recognizing a degree of stain on the banknotes, the denominations of which have been recognized, according to two fitness categories for a fit note and an unfit note, and a plurality of banknote bundling units, each including a plurality of bundling stacking units for stacking the banknotes recognized by the recognition unit to bundle the banknotes, a bundling unit for bundling a predetermined number of banknotes stacked in the bundling stacking units to prepare a banknote bundle, and a bundle dispensing unit for dispensing the banknote bundle prepared by the bundling unit to the outside of the apparatus, wherein
the banknote sorting program causes the banknote processing apparatus to execute:
recognizing fit notes and unfit notes of a plurality of specific denominations via the recognition unit; and
controlling, based on a recognition result of the banknotes at the recognizing, the transport unit to stack fit banknotes of the specific denominations in bundling stacking units corresponding to fit notes of the specific denominations and stack unfit banknotes of the specific denominations in bundling stacking units corresponding to unfit notes of the specific denominations.
